(19) United States
(12) Patent Application Publication
(10) Pub. No.: US 2024/0402568 A1
(43) Pub. Date: Dec. 5, 2024

(54) OPTICAL PARAMETRIC OSCILLATOR-BASED MOLECULAR SENSOR

(71) Applicant: California Institute of Technology, Pasadena, CA (US)

(72) Inventors: Robert M. Gray, Pasadena, CA (US); Selina Zhou, Pasadena, CA (US); Mingchen Liu, Pasadena, CA (US); Arkadev Roy, Pasadena, CA (US); Alireza Marandi, Pasadena, CA (US)

(73) Assignee: California Institute of Technology, Pasadena, CA (US)

(21) Appl. No.: 18/317,533

(22) Filed: May 15, 2023

Related U.S. Application Data
(60) Provisional application No. 63/342,894, filed on May 17, 2022.

(51) Int. Cl. G02F 1/35; G02F 1/39

(52) U.S. Cl. CPC G02F 1/3546; G02F 1/3534; G02F 1/395; G02F 2203/15

(57) ABSTRACT

A sensor including a resonator comprising a nonlinear material comprising a nonlinear susceptibility configured to convert a pump electromagnetic wave (EM) wave to a signal EM wave and an idler EM wave, wherein at least one of the pump EM wave, the signal EM wave and/or the idler EM wave is fed back through the nonlinear material to form one or more resonant EM waves. An actuator coupled to the resonator or a pump path to the resonator, controls at least one of a pump power of the pump EM wave, a detuning of the frequency modes of the resonator relative to one or more frequencies of the resonant EM waves, or a phase matching of the nonlinear material. An output of the resonator outputs one or more output EM waves comprising information about a sample coupled to the resonator.

### CROSS REFERENCE TO RELATED APPLICATIONS

This application claims the benefit under 35 U.S.C. Section 119(e) of co-pending and commonly-assigned U.S. provisional patent application Ser. No. 63/342,894 filed on May 17, 2022, by Robert M. Gray, Selina Zhou, Mingchen Liu, Arkadev Roy, and Alireza Marandi, entitled “OPTICAL PARAMETRIC OSCILLATOR-BASED MOLECULAR SENSOR” client reference CIT-8825-P, which application is incorporated by reference herein.

### STATEMENT REGARDING FEDERALLY SPONSORED RESEARCH AND DEVELOPMENT

This invention was made with government support under Grant No. FA9550-20-1-0040 awarded by the Air Force. The government has certain rights in the invention.

### BACKGROUND OF THE INVENTION

### 1. Field of the Invention

This invention relates to sensor systems and methods of making and using the same.

### 2. Description of the Related Art

Mid-infrared (IR) is the principal spectral region of interest for molecular sensing where most molecules exhibit strong spectral fingerprints. In contrast to traditional spectroscopy dominated by laboratory analytical equipment or low-cost semiconductor and electrochemical gas sensors, optical gas sensors can offer both fast responses and high gas specificity, filling the gap between lower cost sensors with inferior performance and high-end laboratory equipment [1]. Myriad applications such as medical breath analysis [2] and environmental sensing [3] have motivated extensive efforts on developing broadband coherent spectrometers in the mid-IR for multi-species gas sensing, for instance using dual-comb spectroscopy [4-6]. However, achieving a low-noise, coherent broadband spectrometer in the mid-IR typically requires addressing substantial challenges regarding the source [7] and spectroscopy technique [8]. Mid-IR photodetectors have also imposed barriers (sensitivity, response time, etc.) in making such systems available for many applications. What is needed, then, are more sensitive and faster sensing systems. The present invention satisfies this need.

### SUMMARY OF THE INVENTION

Illustrative embodiments of the subject matter of the present invention include, but are not limited to, the following examples.

1. A sensor, comprising:
a resonator comprising a nonlinear material comprising a nonlinear susceptibility configured to convert a pump electromagnetic wave (EM) wave to a signal EM wave and an idler EM wave, wherein at least one of the pump EM wave, the signal EM wave and/or the idler EM wave is fed back through the nonlinear material to form one or more resonant EM waves;
an actuator coupled to the resonator or a pump path to the resonator, for controlling or modulating at least one of a pump power of the pump EM wave, a detuning of the frequency modes of the resonator relative to one or more frequencies of the resonant EM waves, or a phase matching of the nonlinear material; and
an output of the resonator, for outputting one or more output EM waves comprising information about a sample coupled to the resonator.

2. The sensor of example 1, further comprising:
a detector coupled to the output of the resonator, for detecting an output power of the one or more output EM waves; and
a computer coupled to the detector, wherein the computer is configured to determine the information about the sample from a change in the output power when the resonant EM waves are coupled to the sample.

3 The sensor of example 2, wherein the computer is configured (e.g., programmed and/or comprises circuits) to:
determine the information by comparing the output power to a calculated output power calculated using a model of a response of the resonator coupled to the sample interacting with the resonant EM waves and/or,
determine the information using a machine learning algorithm trained using training data, wherein:
the training data comprises an association between:
a concentration or composition of the sample, and
the output power as a function of at least one of the pump power, the detuning, or the phase matching, and/or
determines the information by only analyzing the change in the output power.

4. The sensor of any of the examples 1-3, further comprising an optical parametric oscillator (OPO) comprising the resonator.

5 The sensor of example 4, wherein the OPO is configured (e.g., phase matched, dispersion engineered, dimensioned, and/or controlled by the actuator) to operate at a phase transition between degenerate and non-degenerate operation.

6. The sensor of example 4, wherein the OPO is configured (e.g., phase matched, dispersion engineered, dimensioned, and/or controlled by the actuator) to:
operate near threshold for lasing of the resonant EM waves, and
the EM comprise simultons,
so that a sensitivity of the sensor to a change in the sample is enhanced by near-threshold dynamics such as simulton or other soliton formation mechanisms.

7. The sensor of any of the examples 4-6, wherein the actuator is configured to change operation of the OPO from below a threshold (for lasing of the resonant EM waves) to above the threshold.

8. The sensor of any of the examples 1-7, wherein the resonator is configured (e.g., phase matched, dispersion engineered, dimensioned, and/or controlled by the actuator) to operate near oscillation threshold for lasing of the resonant EM waves, as characterized by 0.9≤pump power/threshold pump power≤3 or
the actuator is configurable to set the detuning or the phase matching so that the resonator operates at least at a spectral phase transition between degenerate and non-degenerate operation and/or the resonant EM waves comprise simultons.

9. The sensor of any of the examples 1-8, wherein the actuator causes the resonant EM waves in the resonator to follow a predictable spectral tuning and the output EM waves can be used to reconstruct the function of a tunable laser spectrometer.

10. The sensor of any of the examples 1-9, wherein the actuator is configured to modulate at least one of the pump power, the detuning, or the phase matching to tune a dynamic range, sensitivity, or selectivity of the sensor.

11. The sensor of any of the examples 1-10, wherein the information comprises at least a concentration or a composition differentiation of the sample comprising one or more molecules.

12. The sensor of any of the examples 1-11, wherein the information comprises a physical or chemical property of the sample comprising a solid, liquid, or gas.

13. The sensor of any of the examples 1-12, wherein the information is outputted in real time with a change in the sample and with a temporal resolution limited by a modulation/actuation speed of the actuator and acquisition time of the information (e.g., 1 Hz-1 MHz).

14. The sensor of any of the examples 1-13, wherein the actuator comprises at least one of an actuator configured to tune a length of the resonator, a heater and/or cooler thermally coupled to the resonator for modulating the phase matching and/or the length of the resonator, an electro-optic modulator capable of tuning a refractive index of a path length in the cavity, an electro-optic mirror or beam splitter for controlling a power of the pump EM wave, or a control circuit coupled to a pump source for tuning a frequency or power of the pump EM wave outputted from the pump source.

15. The sensor of any of the examples 1-14, wherein the actuator comprises a scanner applying one or more ramp functions modulating at least one of the pump power, the detuning, or the phase matching.

16. One or more chips or photonic integrated circuits comprising the sensor of any of the examples 1-15.

17. The sensor of any of the examples 1-16, further comprising means for making the resonant EM wave of the resonator interact with the sample, wherein the means comprises a sample container positioned to couple the sample to the resonator through an evanescent field, a slot waveguide, an optical fiber, a chamber in the resonator, a fluidic coupling, a free space coupling, or a hollow core fiber.

18. The sensor of any of the examples 1-17, wherein:
the resonator comprises a cavity comprising the nonlinear material between mirrors, and the cavity comprises a sample space for positioning the sample within the cavity.

19. The sensor of any of the examples 1-18, wherein the resonator comprises an optical fiber loop coupled to the nonlinear material.

20. An analyzer comprising the sensor of any of the examples 1-19 configured for outputting the information about the sample comprising breath, an atmospheric concentration of a pollutant or greenhouse gas, or a process gas monitored in an industrial setting.

21. The sensor of any of the examples 1-20, wherein the information comprises a concentration of the sample in a range causing saturation a linear absorption sensor according to the Beer Lambert Law.

22. A method of sensing, comprising:
coupling a sample to a resonator comprising a nonlinear material comprising a nonlinear susceptibility configured to convert a pump electromagnetic (EM) wave to a signal EM wave and an idler EM wave, wherein at least one of the pump EM wave, the signal EM wave or the idler EM wave is fed back through the nonlinear material to form one or more resonant EM wave;
controlling at least one of a pump power of the pump EM wave, a detuning of the frequency modes of the resonator relative to one or more frequencies of the resonant EM waves, or a phase matching of the nonlinear material;
detecting an output power of one or more output EM waves outputted from the resonator; and
calculating information about the sample from a change in the output power in response to the sample and the modulating.

23. A computer implemented system, comprising:
one or more processors:
receiving an output power of one or more output electromagnetic (EM) waves outputted from a resonator when the resonator is coupled to a sample, the resonator comprising a nonlinear material comprising a nonlinear susceptibility configured to convert a pump electromagnetic (EM) wave to a signal EM wave and an idler EM wave, wherein at least one of the pump EM wave, the signal EM wave or the idler EM wave is fed back through the nonlinear material to form one or more resonant photons;
controlling modulation/actuation of at least one of a pump power of the pump EM wave, a detuning of the frequency modes of a resonator relative to one or more frequencies of the resonant photons, or a phase matching of a nonlinear material when the sample is coupled to the resonator, and
calculating information about the sample from a change in the output power in response to the sample and the modulation/actuation.

### BRIEF DESCRIPTION OF THE DRAWINGS

Referring now to the drawings in which like reference numbers represent corresponding parts throughout:

FIG. 1A Schematic of a sensor system. FIG. 1B. Schematic of sensor system comprising an OPO. FIG. 1C. Example output signal from the photodetector as a function of cavity length for the sensor comprising an OPO. The peaks correspond to various resonant conditions in doubly-resonant OPOs. FIG. 1D. OPO output power spectral density at various cavity length detuning values. FIG. 1E. Output signal (at 4 μm) peaks evolution as a function of CO₂ concentration.

FIG. 2A Difference in simulated OPO output power between sensing 4120 and 412 ppm of CO₂. Each “pixel” corresponds to an output power value difference at different input powers (y-axis) and cavity lengths (x-axis). FIG. 2B. Simulated OPO output of sensing CO₂ and N₂O at different concentrations at 1.45 W input power. FIG. 2C. Measured 2 μm depletion signal mirroring 4 μm output signal.

FIGS. 3A-3D: Overcoming the sensitivity vs. dynamic range trade-off imposed by the BeerLambert Law using quadratic cavity solitons. FIG. 3A, Schematic representation of linear absorption sensing governed by the Beer-Lambert Law for light interacting with a sample over a path length L. FIG. 3B, Linear methods (light blue region) face a fundamental limit in dynamic range, with high sensitivities being difficult to achieve at large sample concentrations. In contrast, active cavity sensing with quadratic cavity solitons (orange) can achieve high sensitivities at large sample concentrations. FIG. 3C, Schematic depiction of quadratic cavity soliton sensing in the simulton regime of a synchronously-pumped optical parametric oscillator at degeneracy. The bright soliton in the signal interacts with the sample every round-trip, and the resulting competing nonlinear dynamics generate the signal response measured at the output. FIG. 3D, Specifically, stable simulton operation requires the simulton acceleration leading to a temporal advancement, ΔT, due to gain saturation in the crystal to balance the round-trip delay, ΔT_{RT}, and the parametric gain to balance the sample loss, α, and output coupling. T_{cav}, cavity round-trip time; Tᵣₑₚ, pump repetition period; ΔT, simulton group advance; ΔT_{RT}, round-trip delay; ω, angular frequency; α, absorption coefficient; OC, output coupling; Pᵢₙ, input power; Pₒᵤₜ, output power; L, path length; ℏ, reduced Planck's constant.

FIGS. 3E-3I: Experimental details. FIG. 3E. The experimental setup consists of the 4 μm OPO cavity placed inside a purging box alongside all necessary measurement equipment. FIG. 3F, Calibration curve for mapping the voltage on the pump photodetector to optical power with the goodness of fit indicated. FIG. 3G, Corresponding calibration curve for the signal. FIG. 3H, Example of the raw trace measured by the 4 μm photodetector as the round trip delay in the cavity is scanned at 406 ppm (green), 384 ppm (orange), and 297 ppm (red). Overlaid traces with different shading correspond to the five traces that are averaged to generate the final value. The inset shows a zoomed-in image of the simulton peak. FIG. 3I, Experimental data corresponding to three different number of times above threshold, showing how fine tuning of the pump power can allow for high sensitivity at desired values of the concentration. The example traces in h. were taken from the data set corresponding to N=2.092. M1, input coupler; M2, output coupler; M3 and M4, concave gold mirrors; OP-GaP, orientation-patterned gallium phosphide crystal; PZT, piezoelectric actuator; MM, magnetic mirror; FTIR, Fourier-transform infrared spectrometer; 92:8, pellicle beamsplitter with 92:8 splitting ratio; PD, photodetector. of the cavity is achieved with nitrogen (N₂) supplied to the cavity. Through adjusting the flow of nitrogen to the cavity, the concentration of CO₂ inside the cavity can be varied. Due to the large size of the purging box and numerous gas outlets, the internal pressure should remain approximately constant. The CO₂ concentration is monitored using a commercial CO₂ sensor (CO₂ meter.com K-30) which records real-time measurements on a computer, enabling calibration of the sensing measurements. The measurement was limited by the specifications of the reference sensor and measurement setup; in particular, the reference sensor has a 20 s response time diffusion and +/−30 ppm accuracy.

FIGS. 4A-4G: Quadratic cavity soliton enhancement mechanism. FIG. 4A, In near-threshold sensing, the addition of sample causes an increase in threshold, resulting in a decrease in signal power at the sensing point. FIG. 4B, The corresponding signal enhancement grows asymptotically as threshold is approached. c, Measured input-output power relationships for the simulton (orange) and conventional (pink) regimes show the extremely high slope efficiency and high threshold of the simulton, suggesting its potential for near-threshold sensing with high SNR. Solid lines capture the trends through linear fits of the experimental data while the orange, dashed line shows the corresponding simulton simulation. d-g. Additional figures of merit for the OPO.

FIGS. 5A-5D: Soliton dynamics responsible for sensing. FIG. 5A, Experimental power spectral densities demonstrate reduced power across the entire simulton spectrum with the addition of sample despite the relatively narrow absorption feature of the CO₂. FIG. 5B. The conventional regime, like other general multi-mode lasers, stands in sharp contrast to the simulton, as the power in nonabsorbing modes increases with the addition of sample, largely compensating the loss in the absorbing modes. This highlights the importance of simulton formation dynamics for enhanced near-threshold sensing in spite of the broad simulton bandwidth. FIG. 5C, Schematic depiction of the temporal dynamics of cavity soliton formation which enable the sensing enhancement mechanism. Additional loss in the round-trip limits the ability of the simulton to deplete the pump and accelerate, leading to a reduced gain for all modes at steady-state. FIG. 5D Simulated steady-state pulse position as a function of gas concentration (left). Comparison with the theoretical gain window (right) shows the simulton moving further towards the gain window edge as the sample concentration is increased, in accordance with FIG. 5E.

FIGS. 6A-6C: Sensing behaviors of the quadratic cavity solitons. FIG. 6A, Measured output power as a function of CO₂ concentration for different number of times above threshold, N, demonstrating the tunability of the region of high sensitivity for the method. The high slope efficiency of the simulton close to threshold leads to a high sensitivity of up to 4.1 mW/ppm, emphasized using the solid trend lines. FIG. 6B, Simulations of the simulton response to the addition of CO₂ at various number of times above threshold exhibit good qualitative agreement with the experimental data. The sensitivity is preserved even for pumps at a different number of times above threshold. FIG. 6C, Equivalent path-length enhancement calculated for neighboring points in the experiment, showing a measured enhancement as large as 2491. Solid lines show the enhancement corresponding to the linear fits in FIG. 6B. The enhancement grows asypmtotically as threshold is approached for a given N. FIG. 6D, Measured sensitivity as a function of CO₂ concentration in direct comparison with linear sensing (light blue), demonstrating the potential for orders of magnitude sensitivity improvement over linear methods at high sample concentrations.

FIGS. 7A-7E: Numerical methods and results. FIG. 7A, Calculated K, the imaginary part of the complex refractive index, for the CO₂ bands of interest at atmospheric levels of CO₂. FIG. 7B, Corresponding result for n′−1, the real part of the complex refractive index. FIG. 7C. Simulated simulton slope efficiency for various values of the output coupling; the experiment most closely corresponds to 0.25, shown in orange. Both the simulton threshold and slope efficiency can be increased by lowering the cavity finesse, which can benefit the sensing performance. FIG. 7D, Simulated sensing behaviors for the three different values of the output coupling shown in FIG. 7E, demonstrating higher sensitivities as the slope efficiency and threshold are increased. FIG. 7E, Steady-state signal pulse position as a function of pump power, shown to trend towards the center of the gain window as the pump power is increased. FIG. 7F, Relative steady-state signal pulse position along the fast time axis with increasing CO₂ concentration for three different number of times above threshold. Note that the observed trend is opposite that of e, illustrating the way in which the gain and loss work as counteracting forces for near-threshold simulton operation. relative concentrations of CO₂, O₂, and H₂O are changed in proportion, while that of N₂ is increased to compensate.

FIGS. 8A-8D: Enhancement calculations for direct comparison with linear absorption sensing. FIG. 8A, Interpolated simulton PSD (blue, dashed line) plotted on top of measured PSD (orange). FIG. 8B, PSD of calculated spectrum corresponding to passage of a signal with the interpolated spectrum from a through 1.2 m of CO₂, for 3 different concentrations. The resulting mode strengths are used as weights for calculating α_{eff}. FIG. 8C, Measured experimental sensitivities for 3 different numbers of times above threshold, compared to the baseline linear sensitivity, S_{base}, and optimum linear sensitivity achieved through path-length multiplexing, Sₒₚₜ. FIG. 8D, Sensitivity enhancement computed through direct comparison of measured sensitivity and S_{base}, as plotted in FIG. 8C. FIG. S3b shows the resulting spectra for three different example concentrations. Using the mode strengths from these calculated spectra as weights along with the provided absorption coefficients, we find Δα_{eff} according to (S12) and plug the resulting value along with the measured values of the intensities I(α) and I(α+Δα) into equation (S9) to compute the equivalent path length enhancement.

FIGS. 9A-9E: Enhanced sensing in a single-mode laser. FIG. 9A, Comparison between the enhancement calculated for the full model including spontaneous emission (orange) and simplified model ignoring spontaneous emission (blue), showing the extreme benefit of near-threshold operation. The y-axis is on a logarithmic scale. FIG. 9B, For a given minimum detectable output power, P_{out,det}, there are two ways to achieve sensing closer to threshold compared to some reference (line 1). The first is increase the slope efficiency (line 2), and the second is to increase the threshold (line 3). FIG. 9C, Increasing the spontaneous decay rate A (or, equivalently, decreasing B, the rate of stimulated emission) can increase the threshold of the laser system without changing the slope efficiency. FIG. 9D, Increasing the output coupling loss, α_{R}, increases the threshold and can also benefit the slope efficiency. FIG. 9E, Increasing other losses increases the threshold but decreases the slope in the same proportion and thus does not enable detector-limited sensing closer to threshold.

FIGS. 10A-10D: Enhanced sensing in a continuous-wave OPO. a, Comparison between the theoretical enhancement from a CW OPO and that of SM ICAS in a laser system, showing the faster growth of the CW OPO as N=1 is approached. FIG. 10B, Output intensity versus input intensity for different values of the output coupling, showing how the output coupling can be increased to simultaneously increase both the threshold and slope efficiency, enabling a better SNR for detector-limited near-threshold sensing in the low-finesse regime. F FIG. 10C, Varying the round-trip loss coming from components other than the output coupling can increase the threshold without degrading the slope efficiency. FIG. 10D, Changing the γ parameter can benefit the system in a similar way to the output coupling by simultaneously increasing the threshold and slope efficiency.

FIGS. 11A-11D. OPO sensor constructed with a doubly-resonant OPO (DRO). FIG. 11A Example schematic of DRO sensing on a bulk platform; FIG. 11B Spectrum of the signal and idler as a function of cavity length tuning, illustrating the different spectral coverages of different OPO peaks; FIG. 11C The out signal and idler power measured by a single photodetector, as a function of cavity length tuning. Note that each point on the OPO peaks in FIG. 11C is an integration across FIG. 11B with respect to wavelength.

FIGS. 12A-12B. OPO sensor constructed with a singly-resonant OPO (SRO). FIG. 12A Example schematic of SRO sensing on a bulk platform; FIG. 12B Wavelength tuning of an SRO through phase matching tuning, such as temperature tuning of the nonlinear crystal.

FIG. 13. Flowchart illustrating a method of making a sensor system.

FIG. 14. Flowchart illustrating a method of sensing.

FIG. 15. Hardware environment for performing one or more computer implemented methods described herein.

FIG. 16. Network environment for performing one or more computer implemented methods described herein.

### DETAILED DESCRIPTION OF THE INVENTION

In the following description of the preferred embodiment, reference is made to the accompanying drawings which form a part hereof, and in which is shown by way of illustration a specific embodiment in which the invention may be practiced. It is to be understood that other embodiments may be utilized and structural changes may be made without departing from the scope of the present invention.

### Technical Description

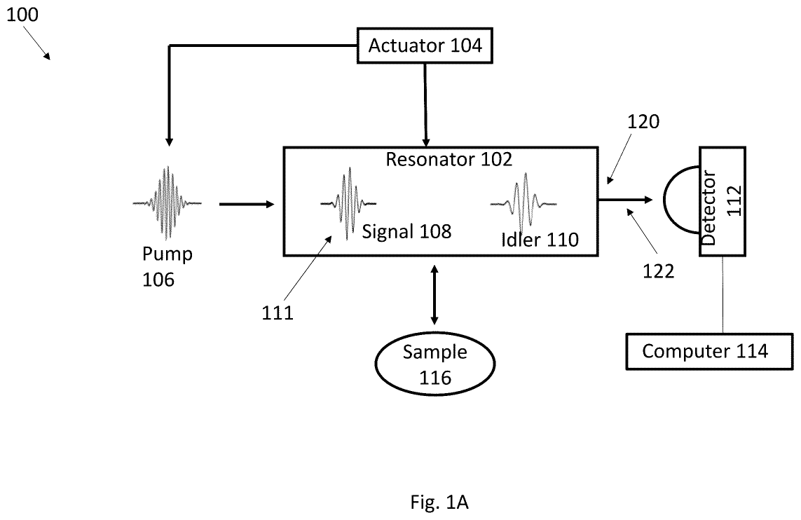

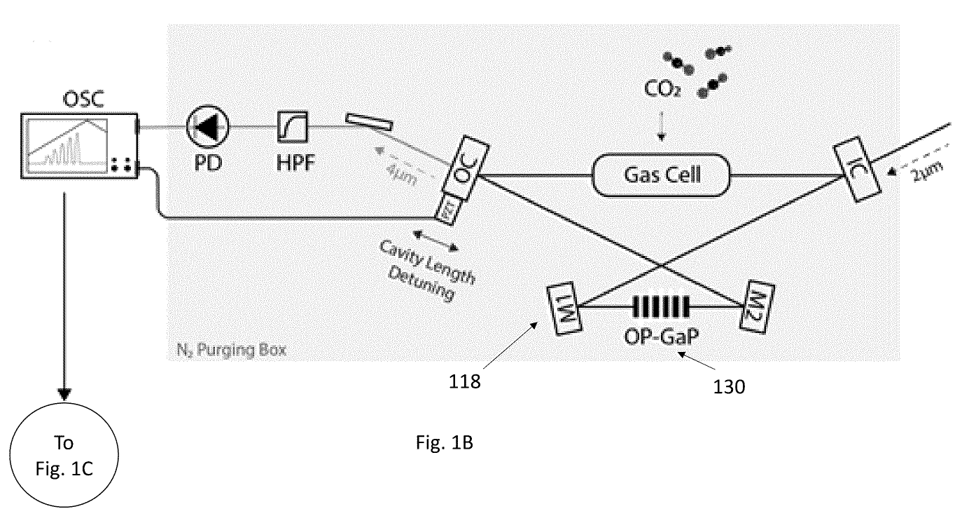

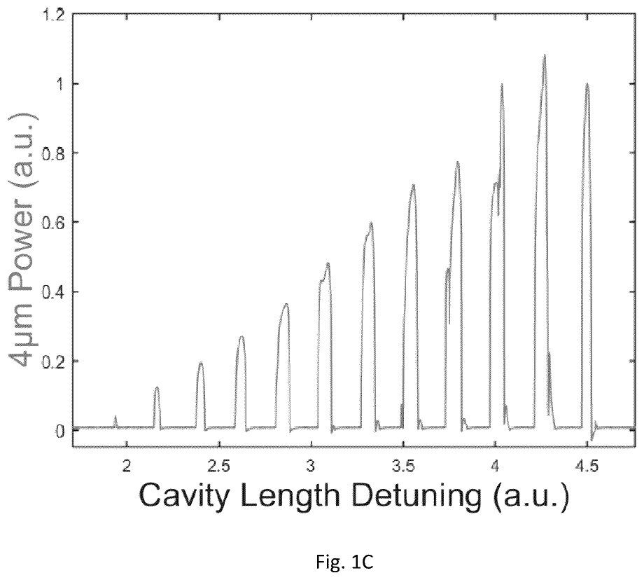

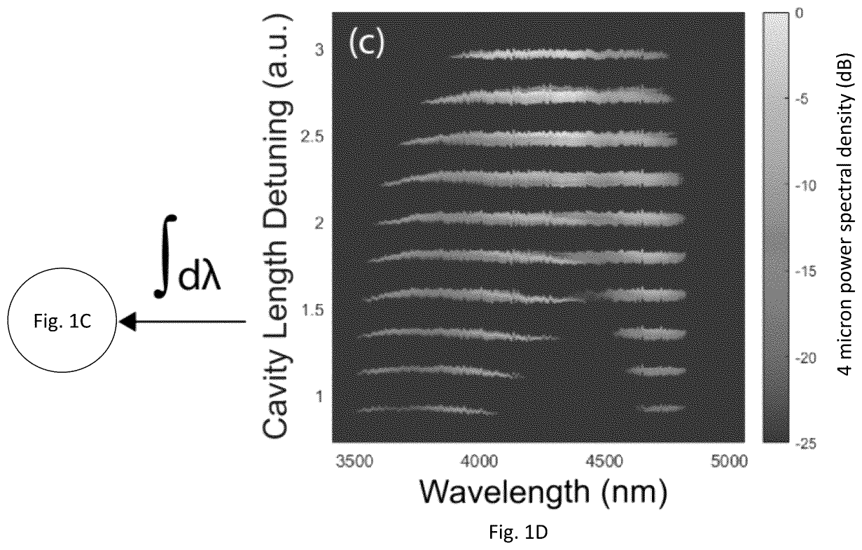

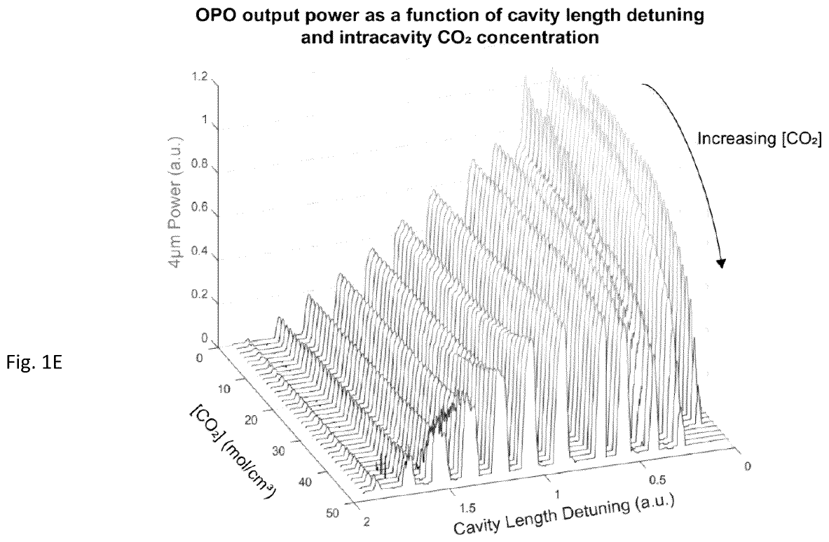

FIG. 1A illustrates a sensor system 100 according to one or more embodiments of the present invention. The sensor comprises a resonator 102 comprising a nonlinear material and an actuator 104 coupled to the resonator. When the resonator is appropriately modulated/actuated by the actuator in the presence of a sample coupled to the resonator, one or more output electromagnetic waves from the resonator comprise information about the sample.

Example resonators include, but are not limited to, resonators configured for nonlinear processes such as three-wave mixing and four-wave mixing and platforms such as free-space cavities based on mirrors, fiber optics, or waveguides (e.g., thin film waveguides), with optical parametric oscillators being an example implementation. The nonlinear material comprises a nonlinear susceptibility configured to convert a pump electromagnetic (EM) wave 106 to a signal EM wave 108 and an idler EM wave 110, and the resonator is configured so that at least one of the pump EM wave, the signal EM wave and/or the idler EM wave is fed back through the nonlinear material to form one or more resonant EM waves. Example materials having the nonlinear susceptibility (e.g., second order nonlinearity) include, but are not limited to, lithium niobate, lithium tantalate, Potassium Titanyl Phosphate (KTP), aluminum nitride, gallium arsenide, indium phosphide, aluminum gallium arsenide, GaP, InGaP, silicon, silicon nitride, or silica. Silicon, silicon nitride, and silica can be used to implement third order nonlinearity, for example. The nonlinear materials can have appropriate phase matching (e.g., periodic poling), dispersion engineering, or a length L of the resonator tailored for the (e.g. second order) parametric amplification/conversion processes convert the pump wave to the signal wave and the idler wave, and/or achieve non-degenerate operation, degenerate operation, near threshold operation or other operation modes and regimes in accordance with the present invention. In one or more examples, the pump wave at a higher frequency (e.g, 20, or second harmonic)) is converted to a lower frequency idler wave and a lower frequency signal wave (e.g., at frequency ω). The pump EM wave can be outputted from a variety of sources of electromagnetic radiation, such as a laser. In some examples, the pump, idler, and signal may comprises pulses of electromagnetic radiation, e.g., femtosecond or picosecond pulses) wherein the resonator is appropriately dispersion engineered to control walk off/pulse overlap. In various examples, the optical pulses each comprise a pulse of electromagnetic radiation having a central wavelength in a range of 200 nm-10 microns, for example.

The actuator is coupled to the resonator or a pump path to the resonator, so as to modulate/control at least one of a pump power of the pump EM wave, a detuning of the frequency modes of the resonator relative to one or more frequencies of the resonant EM waves, or a phase matching of the nonlinear material. Example actuators include, but are not limited to, an actuator (e.g., piezoelectric actuator optionally coupled to a translation stage) to tune a length of the resonator (e.g., either directly or via a mirror), a heater or cooler thermally coupled to the resonator for modulating/controlling the phase matching and/or the length of the resonator, an electro-optic modulator capable of tuning a refractive index of a path length in the cavity, an electro-optic mirror or beam splitter for controlling a power of the pump EM wave, an amplitude modulator or polarizing beam splitter for controlling a power of the pump EM wave, or a control circuit coupled to a pump source for tuning a frequency or power of the pump EM wave outputted from the pump source.

In the embodiment illustrated in FIG. 1A, a detector 112 is coupled to an output of the resonator, so as to detect an output power of one or more output EM waves outputted from the resonator. In one or more examples, a computer 114 coupled to the detector can be used to determine the information about the sample 116 from a change in the output power when the resonant EM waves are coupled to the sample.

FIG. 1A further illustrates a coupling between the sample and the resonator, which can be achieved in a variety of ways. For example, the resonator can comprise, or be coupled to, a cavity for interacting the EM waves with the sample. In one example, the cavity is configured for sensing the sample through an evanescent field, a waveguide, a fiber, or a fluidic coupling. In another example, the cavity comprises a cell (containing the sample, e.g. gas cell) forming part of the cavity.

Further illustrative embodiments and variations of the present invention include, but are not limited to, following examples.

### First Example: Sensor Comprising an Optical Parametric Oscillator

FIG. 1B illustrates a sensor system wherein the resonator is an optical parametric oscillator (OPO). More specifically, the OPO comprises the nonlinear material in a cavity bounded by mirrors M1 and M2. The sample is coupled to the OPO by positioning both the OPO and the sample within a second cavity bounded by mirrors OC (output coupler) and IC (input coupler). In this example, where the sample comprises carbon dioxide gas, the detector comprises a near-IR photodetector (Thorlabs PDAVJ5), and the OPO comprises an orientation patterned gallium phosphide (OP-GaP) nonlinear material within a 4 micron length resonator defined by the cavity mirrors M1 and M2, so that the OPO outputs femtosecond pulses with a wavelength centered around 4 μm [11].

For the date acquired in this example, the sample is contained in a 10 cm path length glass cell with silicon and calcium fluoride windows. The gas cell in the second cavity is contained in a box to flush out atmospheric gases with nitrogen.

FIGS. 1C and 1D show the output power and output spectrum as a function of the second cavity detuning, respectively. The data shows that the output power and the spectrum of the OPO are cavity-length dependent with extreme sensitivity [10,12], so that the information about the spectral features of gas molecules inside the gas cell can be extracted with high sensitivity by monitoring the output power as a function of cavity roundtrip detuning using the photodetector. More specifically, each point on the “detuning peaks” is an integral of the OPO power spectrum across all wavelengths of the output spectra at various cavity roundtrip lengths, as shown in FIG. 1D. When the target molecule absorption lines overlap with the OPO spectrum, spectral information is reflected in the shapes of these peaks due to absorption and dispersion. These features can be very sensitive to the magnitude of absorption and dispersion and their spectral distribution, which can be utilized as the basis for molecular sensing.

FIG. 1E shows the output signal at various CO₂ concentrations, demonstrating that changes in amplitude of the output signal detuning peaks as a function of gas concentration can be used to measure the gas concentration. While conventional spectroscopy relies on direct measurement of absorption peaks at specific wavelengths, the OPO sensor output provides multiple information sources across and within a number of detuning peaks containing different spectral information, without requiring analysis of changes in frequency of the spectrum. For example, FIG. 1E shows the highest output power of the rightmost peak (corresponding to a cavity soliton) decreases as a function of intracavity CO₂ concentrations while other peaks can have the opposite dependence. Cross-referencing other metrics on the peaks can improve the sensitivity and specificity when multiple gases are present.

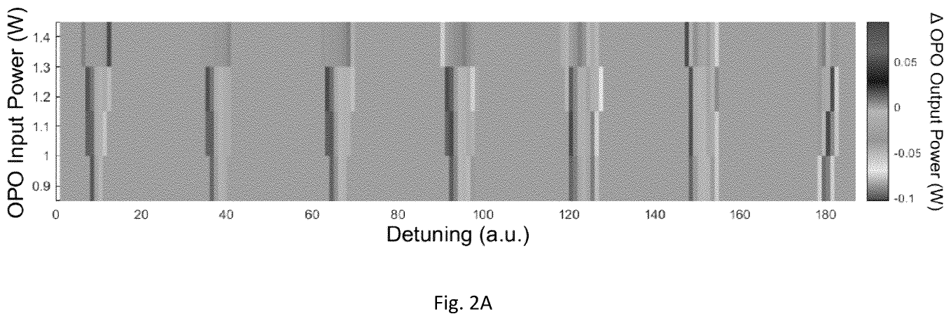

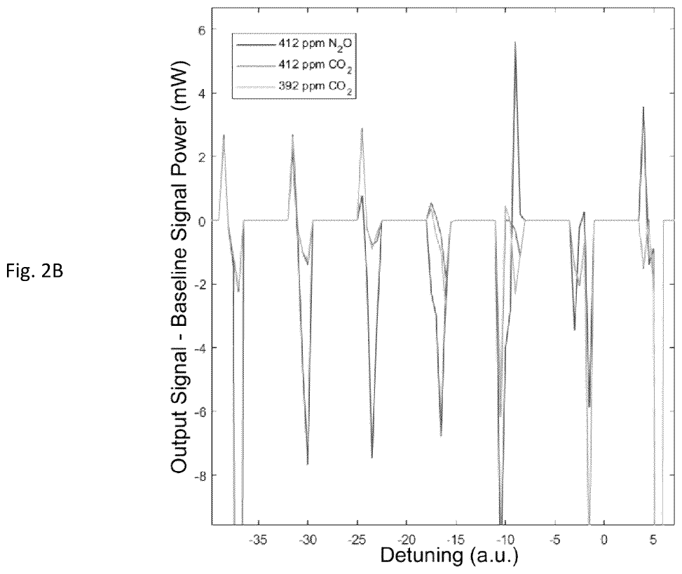

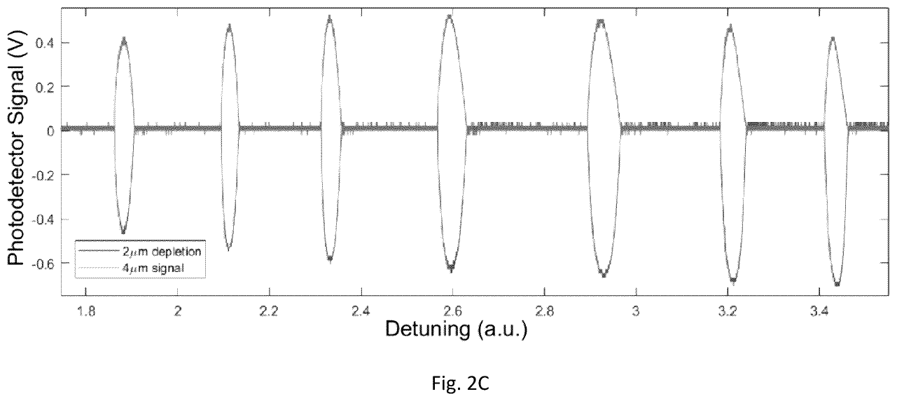

Furthermore, by varying the input pump power (in this example centered at a wavelength of 2 microns) in addition to the cavity length, another dimension is added to the output signal for improving sensitivity, as shown in FIG. 2. FIG. 2a was generated by simulating the output signal of the OPO at two different CO₂ concentrations, 4120 ppm and 412 ppm, then taking their difference. Each “pixel” corresponds to the power difference in the OPO sensor signal at various pump powers (y-axis) and detuning values (x-axis) for these two different concentrations.

Simulated sensing of 392 and 412 ppmCO, as well as 412 ppmN₂O was performed to demonstrate multi-species sensing. FIG. 2b shows the OPO output peaks for various gas concentrations subtracted by a 0 ppm baseline, demonstrating the ability to distinguish between close concentration values and differentiate different gas species. Additionally, due to the nature of half-harmonic generation, the output signal profile is mirrored in input signal depletion, which enables real-time detection of mid-infrared absorptions using a near-infrared detector (FIG. 2c).

While this example illustrates broadband mid-infrared gas sensing from ˜3.5 μm to ˜4.8 μm, this range can be extended by modifying dispersion and loss within the cavity. Implemented with parametric nanophotonics [13], our sensing scheme can enable compact on-chip multi-species gas sensors without requiring mid-IR lasers and detectors. The results presented herein show that the OPO sensor can enable multi-species, broadband, real-time gas sensing for applications such as, but not limited to, exhaled breath analysis, environmental sensing, and process gas sensing (in industrial settings).

### Second Example: Modulation of OPO Operating Regime

a. Sensor Architecture and Sensing Configuration

The formation dynamics of quadratic cavity solitons in OPOs, i.e. temporal simultons, can also be leveraged for molecular sensing³³. The cavity-soliton-based sensing mechanism relies on the extremely high sensitivity of OPO operation to gain and loss in the soliton regime.

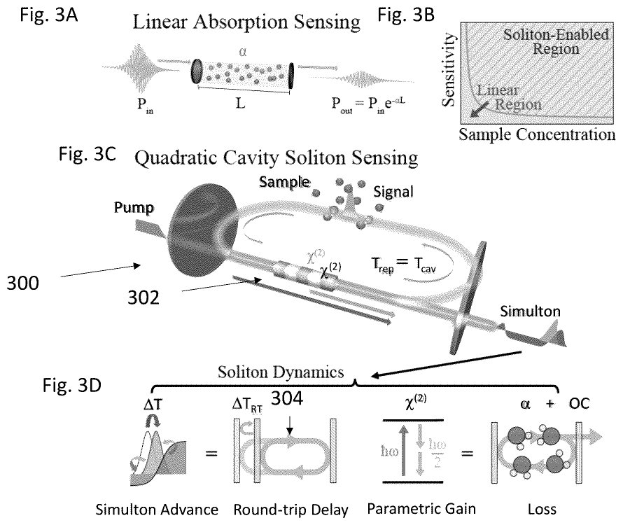

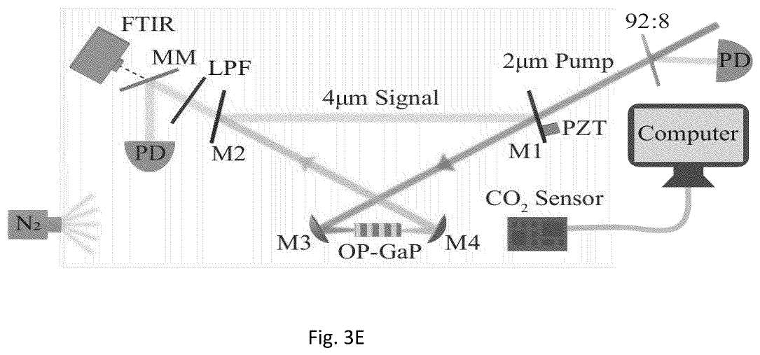

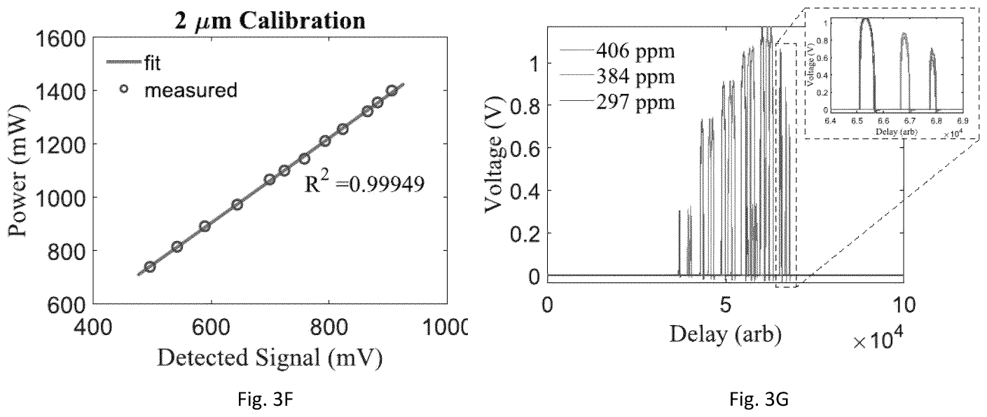

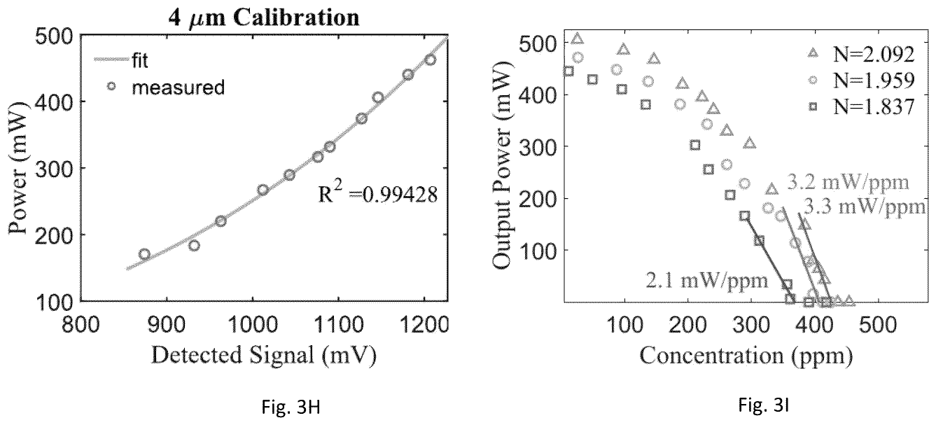

FIG. 3c illustrates an example sensor configured for sensing a gas sample of interest inserted into a doubly-resonant, synchronously pumped OPO around degeneracy. The OPO comprises the optical resonator with the nonlinear material comprising a quadratic nonlinearity, which provides the parametric gain. At degeneracy, the nonlinear interaction is phase matched such that the generated signal and idler light is at the half-harmonic of the pump³⁵. Synchronous pumping occurs when the pump repetition period, Tᵣₑₚ, is matched to the effective signal round-trip time in the cavity while doubly-resonant operation means the OPO permits the signal and idler to resonate in the cavity while the pump is coupled out. In this way, the degenerate signal which resonates in the cavity will experience absorption from the sample followed by gain from the pump through the parametric process in each round trip.

Simultons are bright-dark soliton pairs of the signal at frequency ω and pump at 2ω^{38,39}. Cavity simultons occur in synchronously-pumped degenerate OPOs in the high-gain, low-finesse regime when a round trip delay is added with respect to conventional operation, meaning the cold cavity time, T_{cav}, is increased with respect to the pump repetition period, Tᵣₑₚ³³. FIG. 3d illustrates stable cavity simulton formation requires a double-balance of energy and timing in which the gain must equal the loss and the simulton group advance, ΔT, which occurs as the signal depletes the pump through the nonlinear interaction in the χ⁽²⁾ crystal, must compensate the round-trip delay, ΔT_{RT}, to reestablish synchrony with the pump pulses. The reliance of the timing advance on pump depletion couples the two conditions, as the gain must therefore be sufficiently large for the timing condition to be satisfied, leading to a characteristically strong response to changes in the gain and loss for the simulton near threshold.

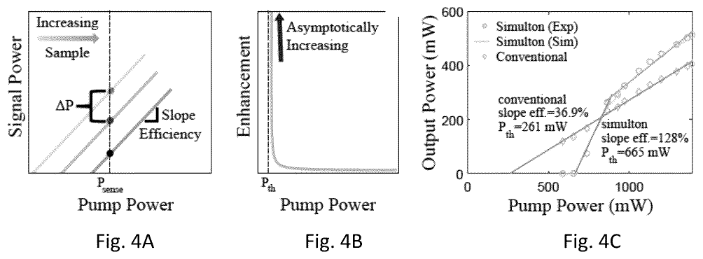

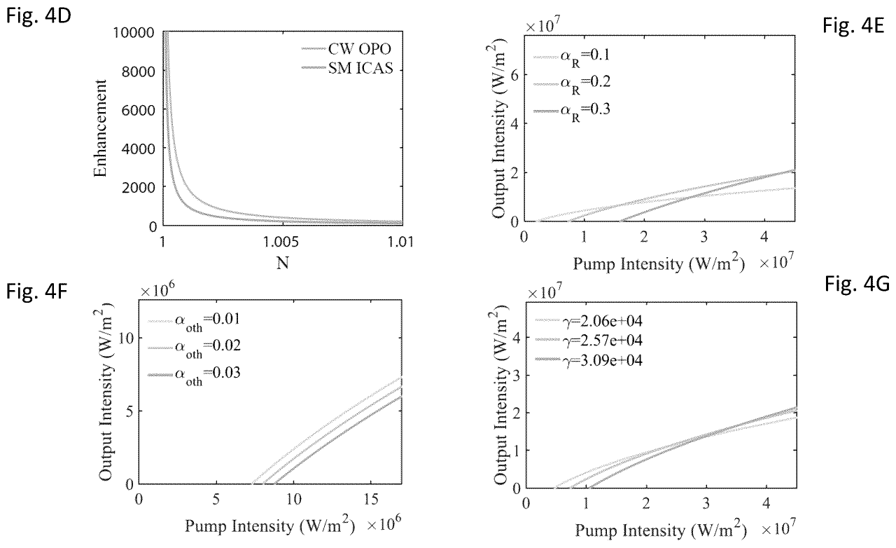

FIG. 2 shows the cavity-soliton-based sensing mechanism exploits the interplay between energy and timing in the simulton regime to attain high sensitivity to the sample of interest, in significant contrast to other active-cavity schemes Without being bound by a particular scientific theory, this significantly enhanced sensitivity can be explained from the distinctively large threshold and high slope efficiency of the simulton, as shown in FIG. 4a. For a given pump power, the addition of a small amount of loss due to the sample causes a threshold increase, resulting in a corresponding decrease in the output power, ΔP. The absolute change in power is proportional to the local slope efficiency at the sensing point, meaning a higher slope efficiency results in a higher sensitivity.

In such an example, the corresponding path length enhancement is given by:

$$\frac{{L}_{eff}}{L} = \frac{- 1}{L Δ α} ln ( \frac{{P}_{signal} ( α + Δ α )}{{P}_{signal} ( α )} ) ,$$

where L_{eff} is the effective path length, L is the cavity round-trip length, P_{signal} is the signal power, a is the sample absorption coefficient, and Aa represents some small change in the absorption due to the addition of sample. Models using single-mode laser theory or continuous-wave OPO theory show the path length enhancement to asymptotically approach infinity as the number of times above threshold, N, approaches unity, as shown schematically in FIG. 4b¹⁷.

This large enhancement near threshold is fundamentally followed by a decrease in the signal-to-noise ratio (SNR). However, the combination of large slope efficiency, high threshold, and low spontaneous emission rate of the OPO in the simulton regime makes this SNR reduction extremely slow. As an example, FIG. 4c shows the measured simulton threshold is approximately a factor of 2.5 larger than that of the conventional regime, and the slope efficiency is a factor of 3.5 larger. The net result is an ability to operate nearly 9 times closer to threshold in the simulton regime at the same output power for detector-limited measurements. This ability to achieve measurable signals very near to the simulton threshold can lead to a significantly large enhancement, making the simulton an excellent candidate for intracavity sensing.

b. Characterization
a. Procedure for Obtaining Measurements

The following results were obtained using a degenerate, synchronously pumped, free-space OPO in a bowtie formation³⁴. The pump is the output of a periodically poled lithium niobate-based OPO which provides a pulse train at 2.09 μm with a 155 nm bandwidth, a 250 MHz repetition rate, and up to 1.4 W of average power. Pulses were coupled in through a dielectric-coated mirror with high transmission for the pump and high reflection for the signal. The input coupler was placed on a stage with a piezoelectric actuator for tuning of the cavity length. Nonlinearity was provided by a 0.5 mm, anti-reflection coated, plane-parallel, orientation patterned gallium phosphide crystal with a poling period of 92.7 μm for type-0 phase-matching between the pump at 2.09 μm and signal at 4.18 μm at room temperature. Two concave gold mirrors with radius of curvature of 24 mm on either side of the crystal provided focusing and collimation. The output coupler was a dielectric-coated mirror which allows 25% output coupling for the signal around 4.18 microns. A piezoelectric actuator (PZT) on cavity mirror M1 allows for tuning of the cavity length for entry into the simulton regime. The cavity can be locked using the dither-and-lock protocol.

The output was passed through a long-pass filter and sent to a MCT detector for monitoring. Spectrum measurements were performed using a commercial Fourier-transform infrared spectrometer. The OPO and all measurement equipment were placed inside a nitrogen purging box. To perform the sensing measurement, the CO₂ concentration was varied through addition of N₂ to the setup. The CO₂ concentration was referenced to a commercially available CO₂ sensor for calibrating the measurements. At each concentration, five data points were taken and averaged to produce the final result.

The procedure was as follows. First, a small fraction of the 2 μm power was siphoned off to a detector using a pellicle beamsplitter with a 92:8 splitting ratio, placed at the input side of the cavity (FIG. 3d). A calibration curve was them obtained (FIG. 3f) mapping the 2 μm power to the detector value using an optical power meter. A similar procedure was used to create a calibration curve for the 4 μm signal in both the conventional and simulton regimes mapping the measured voltage on the photodetector to optical power with the 4 μm OPO cavity locked and purged. An example calibration curve for the simulton can be seen in FIG. 3g. The R2 values for the calibration curves are shown in each plot and indicate the goodness of the fits.

For the sensing measurement, the PZT was continuously scanned with a ramp function supplied by a function generator. This enables near-simultaneous monitoring of all OPO peaks and also allows measurement of the output nearer to threshold, where the locking is generally less stable. The output was measured on the 4 μm photodetector and then mapped to optical power using the calibration curve. Five measurements were taken at each CO₂ concentration using a data acquisition unit, triggered on the ramp function used to scan the cavity length. An example of the raw data that is measured from the system can be seen in FIG. 3h where examples from 3 different CO₂ concentrations, 406 ppm (green), 384 ppm (orange), and 297 ppm (red) are shown. The five different traces are overlaid in different shades; they are for the most part almost identical, but there is some fluctuation due to instability in the locking of our pump OPO and the dynamic nature of our measurement. The inset shows a zoomed-in picture of the simulton peak. Through visual comparison with other peaks, it is clear to see that the simulton exhibits a significantly more dramatic response to the addition of gas. As mentioned above, we believe that the behaviors of the other peaks contain additionally useful information about the gas being monitored, and a sensor designed to utilize data from all of the OPO peaks will be the subject of future works. The final presented value for the output power at any single concentration value, as in FIG. 4a in the main text as well as FIG. 3i, is the result of averaging the five measured simulton peaks and finding the maximum voltage of this averaged measurement which is then mapped back to optical power through the calibration curve. In FIG. 3i, we show this output power as a function of concentration for three different number of times above threshold, N=2.092 (green triangles), N=1.959 (orange circles), and N=1.837 (red squares). These three values are significantly closer together than the values shown above, highlighting the ability to do fine tuning of the pump power to achieve high sensitivity at any concentration of interest.

Numerical simulations were performed following the methods described in ref.³³. The nonlinear propagation through the crystal was computed using the Fourier split-step method to solve the coupled wave equations describing the pump and signal evolution. The round trip propagation was given by a linear filter which includes both the dispersion and frequency-dependent loss. Important to simulating the sensing behavior is an appropriate model for the gas absorption and dispersion in the round trip. For this, a Lorentz oscillator model was used, with parameters taken from HITRAN⁴⁴.

b. Results

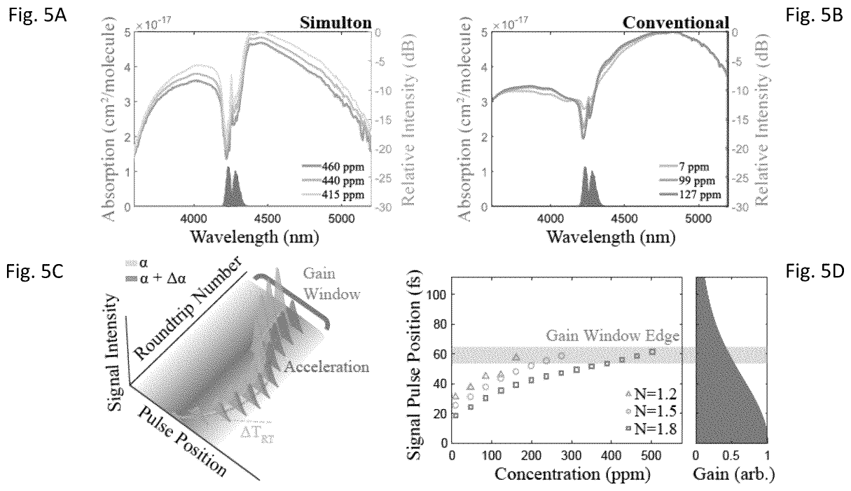

FIGS. 5a and 5b show the experimental spectrum data in both the simulton (FIG. 5a) and conventional regimes (FIG. 5b) for three different intracavity CO₂ concentrations. FIG. 5b shows the cavity-soliton-enhanced sensing cannot be achieved in a general multi-mode laser or conventional OPO wherein other modes which do not experience the absorption will compensate for the loss in the absorbing modes, leading to a limited change in the laser threshold or output power with the addition of the sample¹⁷. Unlike the conventional regime, however, the power in all the spectral modes of the simulton regime (FIG. 5a) decreases nearly uniformly with the addition of even a narrow-band sample, illustrating the possibility of threshold sensing. Moreover, in significant contrast to single-mode lasers, the soliton enhancement provides broadband operation, which relaxes the requirement for fine tuning of the laser line to a single absorption line, as well as providing SNR advantages and sensing in wavelength ranges that are typically not easy to reach with lasers, particularly in the infrared.

FIG. 5c schematically illustrates the formation of the soliton pulses over multiple round-trips in the resonator for two different values of the absorption. Due to the round-trip delay, ΔT_{RT}, the newly formed pulse slowly falls out of the gain window, determined by the pump pulse and walk-off length, until it has grown enough to experience a sufficiently strong nonlinear acceleration to compensate the delay. The addition of a small amount of loss in the round-trip to the signal reduces the amount of acceleration and, correspondingly, the amount of gain experienced by all spectral modes of the simulton super-mode at steady-state, as it interacts with the pump in the nonlinear crystal, leading to a spectrally uniform reduction of power despite the relatively narrow absorption spectrum, as shown in the measured spectrum of FIG. 5a.

The simulation in FIG. 5d confirms this dynamical behavior. FIG. 5d shows the steady state signal pulse position as a function of CO₂ concentration (left) in comparison to the available gain (right) for three different number of times above threshold, N=1.2 (green triangles), N=1.5 (orange circles), and N=1.8 (red squares). The gain is calculated as the convolution between the pump pulse shape and the walk-off, with the center of the gain window positioned at 0 fs. The approximate gain window edge can be calculated by halving the sum of the pump pulse length and the walk-off length. As the sample is added to the cavity, the steady-state position of the signal pulse moves towards the gain window edge due to the reduced acceleration of the simulton until it no longer experiences sufficient gain to resonate. This significant (and sharp) reduction in gain as sample is added to the cavity can enable a high sensitivity for the simulton near threshold.

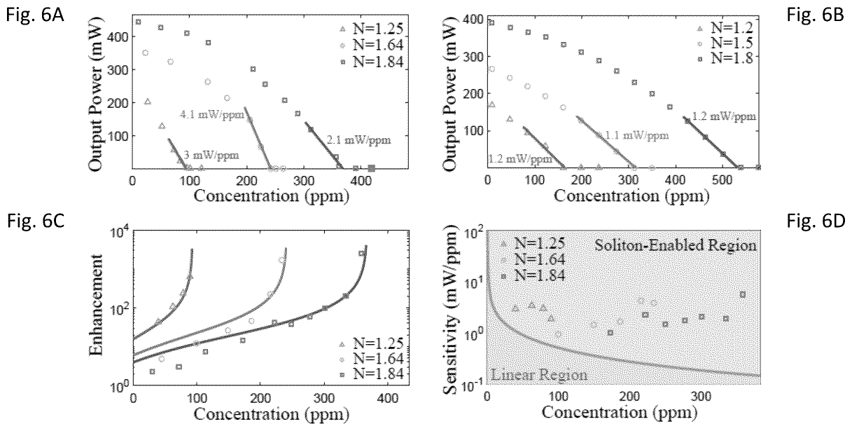

FIG. 6a plots the measured simulton output power as the CO₂ concentration in the cavity is varied. Green triangles, orange circles, and red squares correspond to pumping at different number of times above threshold (here, N=1.25, 1.64, and 1.84, respectively). Similar to the input-output power dependence shown above, the output power dependence on CO₂ changes most sharply close to threshold. Solid lines show linear fits of the near-threshold data. Their slope is used to find the sensitivity, with the highest fitted sensitivity calculated to be 4.1 mW/ppm. In addition, the data shows that by tuning the pump power, the region of high sensitivity can be changed, enabling a large dynamic range for the system.

These observations are consistent with the simulated sensing results in FIG. 6b which illustrate the large sensitivity near threshold and tuning of the sensitive region through variation in the number of times above threshold. The calculated sensitivity is also shown to be consistent across the different pump conditions. The simulated sensitivity is slightly lower than the experimentally observed results. The difference is attributed primarily to imperfections in the modeling of the gas response.

FIG. 6c illustrates the equivalent path length enhancement for the experimental data. The enhancement is found by defining Δα_{eff} as the effective absorption coefficient experienced by a pump of the same bandwidth as the simulton which has experienced 1.2 m of CO₂ absorption at the reference concentration. Using this definition,

$$\frac{- 1}{L Δ {α}_{eff}} ln ( \frac{{P}_{signal} ( {α}_{eff} + Δ {α}_{eff} )}{{P}_{signal} ( {α}_{eff} )} )$$

is calculated for neighboring points in the experimental measurement. The largest enhancement of 2491 is observed near threshold for the case where N=1.84, though similar enhancements are observed near threshold for the other cases. Solid lines show the enhancement corresponding to the linear fits from FIG. 6a in accordance with theory. The close fits near threshold illustrate the nearly asymptotic trend for the enhancement, with deviations at lower sample concentrations coming from the observed saturation of the simulton response far above threshold.

FIG. 6d shows the sensitivity in mW/ppm, calculated for neighboring points in the experimental measurement. Note that through variation of the number of times above threshold, a sensitivity near the measured value of 4.1 mW/ppm may be achieved across all concentrations. Also plotted are the sensitivities achievable using linear methods (light blue region). Modeled is a linear cavity with a length of 1.2 m pumped by a pulsed source with the same bandwidth as our measured simulton and an average power of 500 mW, and assuming a path-length-multiplexed approach in which the path length enhancement is varied to achieve the maximum sensitivity at each point, up to an enhancement of 10⁶ and corresponding finesse of over 1.5 million, compared to our cavity which has a finesse of 2. We believe this to be a large enough enhancement limit for linear methods to represent practically achievable values of the finesse. As with theory, an inverse scaling is observed for this path-length-multiplexed approach, emphasizing the limitations in dynamic range of linear techniques. In contrast, the nearly constant and orders of magnitude higher sensitivity demonstrated by the simulton sensing mechanism at large sample concentrations illustrates how the simulton sensing regime breaks the trade-off between sensitivity and dynamic range faced by linear methods. Thus, many applications utilizing simulton sensing may reap the benefits while avoiding the typical requirements of high-finesse cavities.

The remarkable sensing performance of the simulton could be further improved in several ways. In some configurations, OPOs exhibit multiple simulton resonances as the cavity length is further increased. These further-detuned simultons can exhibit even higher slope efficiencies, leading to potentially larger sensitivities and sensitivity enhancements³³. Additionally, simultons benefit from operation in the high-gain, low-finesse regime. OPO implementations using thin-film lithium niobate nanophotonics, where gains as large as 100 dB/cm have been demonstrated, can further enhance the high-sensitivity, highly scalable molecular sensors^{40,41}. Moreover, other nonlinear behaviors in OPOs such as spectral phase transitions can be used as additional means to achieve high sensitivity for intracavity sensing in OPOs⁴². The OPO operating the in the simulton regime can also be configured for multi-species molecular sensing.

### Third Example: Numerical and Calculation Methods

In this section, the methods used for computing the numerical results presented in the second example, or example methods to perform calculations to determine information about the sample from the output power, are described. The simulations are primarily based on the methodology presented in ref.²

The round trip propagation of the signal in the cavity is modeled in two parts: the nonlinear interaction of the pump and signal in the crystal and the free space propagation of the light around the cavity, described by a linear transfer function. The nonlinear interaction is essentially a single-pass optical parametric amplification (OPA), governed by the coupled wave equations,

$${d}_{z} {E}_{ω} ( z , t ) = κ {E}_{2 ω} {E}_{ω}^{*} - \frac{{α}_{ω}}{2} + {\hat{D}}_{ω} {A}_{ω}$$

$${d}_{z} {E}_{2 ω} ( z , t ) = - κ {E}_{ω}^{2} - \frac{{α}_{2 ω}}{2} - {Δβ}^{′} \frac{\partial {E}_{2 ω}}{\partial t} + {\hat{D}}_{2 ω} {E}_{2 ω} ,$$

where t, the time coordinate, is set to be co-moving with the group velocity of the signal wave, and the pump envelope phase is shifted by π/2 to ensure real solutions if higher order dispersion is not considered. The subscripts ω and 2ω refer to the signal and pump, respectively. The field envelopes are given by Eⱼ, where j∈{ω, 2ω}, and are normalized such that the instantaneous power is given by |Eⱼ|². The strength of the nonlinear interaction is governed by the nonlinear coupling coefficient, κ=\sqrt{2η₀}ωd_{eff}/(w₀n_{ω}\sqrt{πn_{2ω}}c), where η₀ is the impedance of free space, d_{eff} is the effective nonlinearity, w₀ is the Gaussian beam waist inside the crystal (assuming the crystal length is small compared to the confocal parameter), nⱼ is the refractive index, and c is the speed of light. The absorption coefficients, αⱼ, account for the material loss in the crystal. Δβ′ gives the group velocity mismatch between pump and signal. Finally, the dispersion operator

$${\hat{D}}_{j} = {\sum }_{m = 2}^{∞} [ \frac{{( - i )}^{m + 1} {β}_{m}^{( m )}}{m 15} ] {\partial }_{t}^{m}$$

describes the material dispersion experienced by the pump and signal in the crystal.

Simulation of the nonlinear step in each round trip is done using the split-step Fourier method. For this, the spatial coordinate z, corresponding to propagation distance into the 0.5 mm crystal, is divided into 50 discrete steps. In a given step, the output of the nonlinear interaction is solved numerically using a fourth-order Runge-Kutta method. Then, a linear filter accounting for the dispersion and loss in the step is applied in the frequency domain. Dispersion is computed to fourth order using the Sellmeier equation for GaP found in ref.³.

After the nonlinear step is completed, we apply an additional linear filter in the frequency domain to account for the round trip propagation of the beam. Specifically, the input to the coupled wave equations for round trip n+1, Eωⁿ⁺¹(0, t), is related to the output from the previous OPA, E_{ω}ⁿ(L, t), where L is the length of the crystal, by the equation

$${E}_{ω}^{n + 1} ( 0 , t ) = {ℱ}^{- 1} \{ {e}^{- \frac{α ( Ω )}{2}} {e}^{- i Φ ( Ω )} ℱ \{ {E}_{ω}^{n} ( L , t ) \} \}$$

Here, [symbol] and [symbol] ⁻¹ represent the Fourier and inverse Fourier transforms, respectively, and Ω is the normalized Fourier frequency coordinate. The absorption coefficient α(Ω) accounts for the frequency-dependent losses in the cavity coming from the mirrors, the output coupling, AR coatings on the crystal surface, and the gas in the cavity. Similarly, the accumulated roundtrip phase, measured relative to a perfectly synchronous signal pulse, is considered in Φ(Ω)=ΔT_{RT}(πc/λ_{2ω}+Ω)+ΔΦ(Ω), where ΔT_{RT} is the cavity detuning, c is the speed of light, and λ_{2ω} is the pump wavelength. ΔΦ(Ω) contains the dispersion terms from the various cavity components as well as from the gas.

Accurate simulation of the sensing behavior is provided by a model for the gas. In our simulation, we use the Lorentz oscillator model to compute the complex refractive index experienced by the signal in the round trip⁴. Specifically, the index, n(Ω), is given as

$${n}^{2} ( ω ) = 1 + {\sum }_{i j} \frac{{f}_{i j} {N}_{j} {q}^{2}}{2 {ε}_{0} {m}_{e} ( {ω}_{i j}^{2} - {ω}^{2} + i {γ}_{i j} ω )} ,$$

where the indices i,j refer, respectively, to the upper and lower state of the transition of interest, fᵢⱼ is the oscillator strength, Nⱼ is the density of molecules in state j, q is the electron charge, ε₀ is the vacuum permittivity, mₑ is the mass of an electron, ωᵢⱼ is the center frequency of the transition, and γᵢⱼ is the linewidth of the transition. For accurate computation of the response from our experiment, we consider the most abundant atmospheric gases, including N₂, O₂, H₂O, and, of course, CO₂, with parameters taken from the HITRAN database⁵. All simulations assume room temperature and atmospheric pressure. To mimic the experimental procedure in which change in the CO₂ concentration is achieved through purging with nitrogen, a

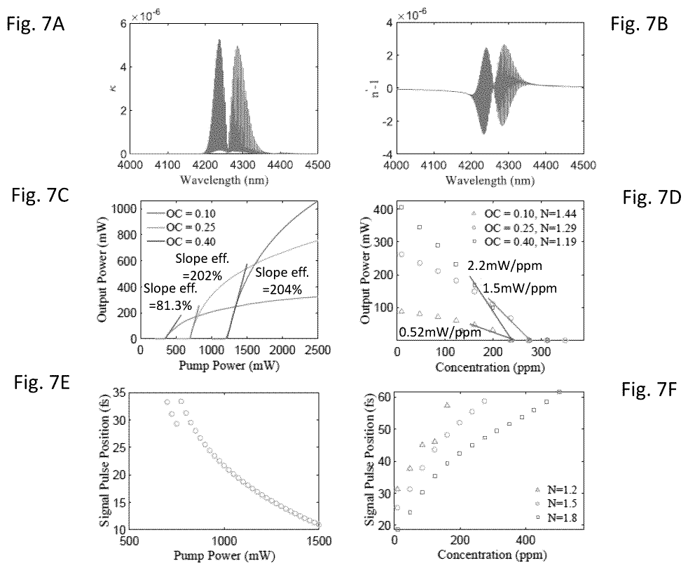

After computing the complex refractive index using Equation S3, the absorption and dispersion can be separately considered from the relationship

$$n ( ω ) = {n}^{′} ( ω ) - i κ ( ω )$$

where the real part of the refractive index, n′(ω), contains the dispersion information and the imaginary part κ(ω) defines the contribution to the loss. Examples of the imaginary and real parts of the complex refractive index for the CO₂ bands of interest at atmospheric concentrations can be found in FIG. 7a and FIG. 7b, respectively. Interestingly, while much of our theoretical analysis in this example centers around the impact of loss, we have found that accurate simulation of the sensing behavior additionally requires a correct model for the dispersion.

Besides helping to confirm the behaviors observed in experiment, our numerical analysis can help to extend those results to different regimes where the sensing performance may be further improved. In FIGS. 7c and 7d, we highlight the importance of low-finesse operation for the observed sensing behavior. As mentioned in the main text and analytically demonstrated in section b. below, the sensitivity benefits from a higher slope efficiency and a higher threshold. In the simulton regime, both the slope efficiency and threshold can be increased through use of a low finesse cavity. FIG. 7c shows the output power as a function of input power for output coupling values of 0.1 (green), 0.25 (orange), and 0.4 (red), with an output coupling value of 0.25 being approximately correspondent to our experiment. Here, we observe a threshold increase from around 350 mW for an output coupling of 0.1 to around 1200 mW for an output coupling of 0.4. Additionally, we see that the slope efficiency more than doubles, from an efficiency of 81.3% to 204%. Correspondingly, we note a more than 4-fold increase in the sensitivity, as illustrated in FIG. 7d. This ability to achieve both a higher slope efficiency and threshold in the simulton regime through low-finesse operation is critical to the uniquely large sensitivity enhancement provided by the simulton.

Additionally, our numerical results can help us to better understand the nonlinear dynamics involved in simulton formation which contribute to the sensing. As shown in FIGS. 5c and 5d, it is the interplay of the energy and timing conditions which result in the enhanced sensing behavior for the simulton. Specifically, in FIG. 5d, we illustrate that the dynamical feature responsible for the high sensitivity is the movement of the steady-state signal pulse position away from the center of the gain window as loss is added to the cavity. The gain window is determined by the pump pulse and walk-off length and can be approximately found by convolving the pump pulse (here, a sech-shaped pulse with duration of 35 fs) with a square pulse of duration equivalent to the walk-off length, Δβ′L (here, 72 fs). The steady-state signal pulse position is computed by finding the “center of mass” of the signal,

$$\frac{{\sum }_{i} {P}_{i} {t}_{i}}{{\sum }_{i} {P}_{i}} ,$$

where Pᵢ and tᵢ represent the pulse power and time in the i^{th} Fourier bin. The “center of mass” metric is useful in providing consistency across measurements, since the addition of sample tends to distort the temporal features of the pulse.

To further emphasize the opposing roles of the gain and loss, we contrast the steady-state pulse position as a function of pump power (FIG. 7e) with the pulse position as a function of concentration (FIG. 7f). In both cases, 0 fs along the y-axis represents the center of the gain window. Here, we see that the addition of gain through increasing the pump power pushes the steady-state pulse position towards the center of the gain window while the addition of loss pulls it away. Thus, we see how the same interplay of energy and timing which result in a high slope efficiency for the simulton regime can also enable high sensitivity. The observed jump in FIG. 7e near 775 mW is an artifact resulting from the discrete nature of the simulation. To mimic the experiment, in which we generally lock to the detuning value ΔT_{RT} which gives the maximum power, we simulate multiple detuning values and record the one which results in the highest output power. As the pump power is increased, this optimum detuning can change, resulting in a discrete jump such as the one observed; however, we believe the behavior should be smooth for the experiment for which the detuning can be continuously varied.

a. Comparison with Linear Absorption Sensing

In analyzing the performance of our method, it is helpful to perform a direct comparison with linear absorption sensing (LAS). The analysis here is informed by the presentation in ref. 6. We begin with the Beer-Lambert Law for light of intensity Iᵢₙ passing through a sample of length L with absorption coefficient α which says that the output intensity, Iₒᵤₜ, is given by

$${I}_{o u t} = {I}_{i n} {e}^{- α L}$$

The most common way of quantifying sensitivity enhancement is to consider the path length enhancement. This metric is particularly appropriate for cavity-enhanced sensing, where the physical mechanism at play can be directly understood as an increase of the interaction length between the light and the sample. In a linear cavity of length L with mirror transmission T and reflection R (in intensity) filled with the absorbing sample, the input-output power relationship is given as

$${I}_{o u t} / {I}_{i n} = \frac{{T}^{2} {e}^{- α L}}{{( 1 - R {e}^{- α L} )}^{2}} \approx \frac{{T}^{2}}{{( 1 - R )}^{2}} ( 1 - \frac{α L ( 1 + R )}{1 - R} )$$

The approximation made here is to expand the entire expression to first order in α. By noting that

$$\frac{α L ( 1 + R )}{1 - R} \approx \frac{2 \sqrt{R} L α}{1 - R} = \frac{2 FL α}{π} ,$$

where F is the cavity finesse, and making use of the fact that T≈1−R, we find that

$${I}_{o u t} / {I}_{i n} \approx 1 - α \frac{2 F L}{π} \approx {e}^{- α {L}_{eff}}$$

where we have defined

$${L}_{eff} = \frac{2 F L}{π} ,$$

the effective path length. This is just the typical BeerLambert Law but with the path length L replaced by L_{eff}. Thus, we see that the linear cavity enhances the path length by a factor of

$$ξ = \frac{{L}_{eff}}{L} = \frac{2 F}{π}$$

Comparing (S7) with equation (S5), we can then find a direct expression for the path length enhancement, ξ:

$$ξ = \frac{{L}_{eff}}{L} = - \frac{1}{α L} ln \frac{{I}_{o u t}}{{I}_{i n}}$$

This expression is very practically useful as it enables the computation of ξ or, equivalently, L_{eff} from measured values of the intensity. It can also be generalized to include measurements where some baseline concentration of the sample exists already in the system. In particular, if the output intensity is measured before and after the addition of some small amount of sample, Aa, the expression becomes:

$$ξ = - \frac{1}{Δ α L} ln \frac{{I}_{o u t} ( α + Δ α )}{{I}_{o u t} ( α )}$$

This is equivalent to equation (1) above, though we have, in equation (1), replaced intensities with powers under the assumption that the spatial profile of the beam remains constant between measurements such that the mode area can be taken out of both the numerator and denominator. It is clear then that with knowledge of Δα, the path length L, and a measurement of the change in power as sample is added, one can easily calculate the path length enhancement. With that said, computation of this quantity using solely the measured change in intensity for a broadband signal requires slightly more care since α=α(ω) is a function of frequency. To address this, we consider the case of performing LAS with a multimode source containing several frequency modes i such that Iᵢₙ=ΣᵢI_{in,i}. Then, the Beer-Lambert Law would suggest the following expression for the output intensity given that each frequency mode experiences an absorption coefficient αᵢ.

$${I}_{o u t} = {\sum }_{i} {I}_{o ut , i} = {\sum }_{i} {I}_{in , i} {e}^{- {α}_{i} L} = {I}_{i n} {e}^{- {α}_{eff} L}$$

Assuming αᵢL small, we find

$${I}_{o u t} \approx {\sum }_{i} {I}_{i n , i} - {\sum }_{i} {I}_{i n , i} {α}_{i} L \approx {I}_{i n} - {I}_{i n} {α}_{eff} L$$

Dividing by IᵢₙL and rearranging terms, we arrive at the following expression for α_{eff}.

$${α}_{eff} = \frac{{\sum }_{i} {I}_{i n , i} {α}_{i}}{{I}_{i n}}$$

α_{eff} is given by a weighted sum of the αᵢ′s with the various mode intensities, normalized to the total intensity, as weights. Using this expression, one can extend equation (S9) to the case of a broadband source as long as the spectral shape of the source is known.

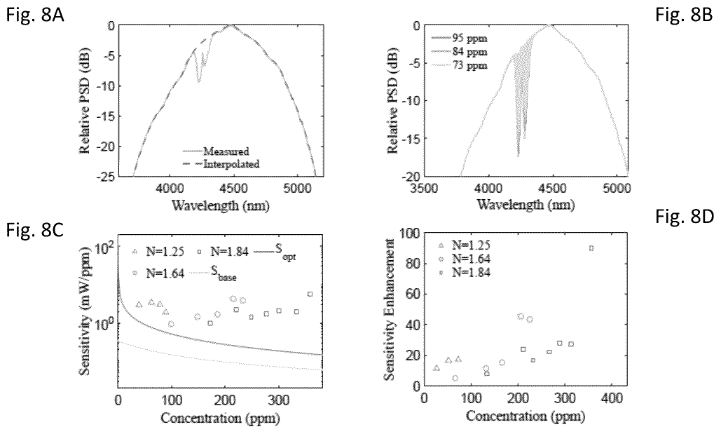

These results allow us to make a comparison between the experimentally measured simulton behavior and linear methods. To do so, we calculate the equivalent path length enhancement, which is the enhancement that would be necessary for a source with the same spectrum as the simulton at the reference absorption, α, to experience the same change in intensity with the further addition of sample, Δα, in a linear cavity. For this computation, we first take our experimental simulton spectrum for the purged cavity with a measured CO₂ concentration of 11 ppm (FIG. 8a, orange line) and use interpolation to reconstruct the CO₂-free spectrum (blue, dashed line). We then use the CO₂ absorption spectrum provided by HITRAN to estimate Pᵢ(αᵢ), the mode strengths of a source with a spectrum equivalent to the simulton, after propagation through 1.2 m of a sample with modal absorption coefficients αᵢ assuming no enhancement s.

As shown in FIG. 4c of the main text of the paper, the calculated enhancement is significant, reaching a value as large as 2491. Using the L_{eff} defined for equation (S7), we see that this is equivalent to the enhancement provided by a cavity with a finesse of 3912. This is important as it demonstrates the ability of quadratic cavity solitons in a low-finesse cavity near threshold to achieve similar sensitivity enhancements to those achieved through linear methods in highfinesse cavities.

The measurement of path length enhancement, as defined in (S9), serves primarily to quantify relative power rather than sensitivity. Additionally, it is difficult to make fair comparisons since the enhancement in the simulton case is not coming from an extension of the path length but from the nonlinear dynamics which result in a broadband loss. This difficulty is especially pronounced in the case where there is already some significant baseline level of sample in the cavity, where linear methods will generally have already experienced significant depletion in the absorbing modes that would not be seen in the simulton spectrum used for calculation of α_{eff}. Thus, it is also worthwhile to make a direct sensitivity comparison with LAS for a pump with the same optical properties as the output of our simulton OPO. Let us begin by analytically calculating the sensitivity of LAS. The sensitivity is the rate of change of the signal, Iₒᵤₜ, with respect to the absorption coefficient, given as the derivative of (S5):

$$S = \vert \frac{{dI}_{o u t}}{d α} \vert = {I}_{i n} L {e}^{- α L} .$$

From this, we see that the maximum sensitivity occurs when α=0 and is given by Iᵢₙ L. This sensitivity can be quite large, given the large effective path lengths that can be achieved in high-finesse cavities. Comparison of the enhanced sensitivity, Sₑₙₕ, of a system with effective path length L_{eff} and the sensitivity, S_{base}, of a baseline LAS system with path length L gives the following expression for sensitivity enhancement, ξ:

$$ζ = \frac{{S}_{e n h}}{{S}_{b a s e}} = \frac{{L}_{eff}}{L} {e}^{- α ( {L}_{eff} - L )}$$

Here, we have assumed both systems are pumped with the same power. At α=0, we see that the sensitivity enhancement does correspond exactly to the above computed path length enhancement, ξ. In considering dynamic range, however, it is clear that this sensitivity enhancement quickly decays with increasing α for L_{eff}>L. This gives rise to an inherent trade-off between sensitivity and dynamic range in the linear case, since achieving a higher sensitivity near α=0 through increasing of L (or, equivalently, L_{eff}) results in significantly lower sensitivities at larger values of α. Thus, direct consideration of the sensitivity enhancement is also important for discussion of dynamic range. To perform this comparison, we seek the maximum attainable sensitivity using linear methods for arbitrary α. By optimizing (S13) with respect to L, we find the sensitivity is maximized when

$$L = \frac{1}{α} .$$

This results in the optimized sensitivity:

$${S}_{opt} = \frac{{I}_{i n}}{e α}$$

This optimized sensitivity, which is inversely related to α, defines the sensitivity limit for LAS shown in FIG. 3 b and FIG. 6d. For the comparison plot in FIG. 6d, we assume a source with the same bandwidth as the simulton and an average power of 500 mW, which is approximately the maximum output power of our system when fully purged. In practice, the asymptotic behavior near α=0 for LAS is limited by spatial constraints and the finesses achievable with available cavity mirrors. For our comparison, we assume a cavity length of 1.2 m, the same as the size of our OPO system, and a maximum path length enhancement of 10⁶, corresponding to a finesse of over 1.5 million. We believe this to be a fair choice as such a high finesse is extremely difficult to achieve in practice, particularly over such a large bandwidth.

The sensitivity given by equation (S13) and sensitivity enhancement (S14) are plotted for our measured data in FIGS. 8c and 8d. FIG. 8c is very similar to FIG. 6d of the main text, but here we have distilled the linear region into two lines, the sensitivity limit, Sₒₚₜ, and the baseline sensitivity, S_{base}, computed for a source of the same bandwidth and power as the simulton, as discussed in the preceding. FIG. 8d, then, shows the corresponding sensitivity enhancement, found by taking the ratio of our measured sensitivity and S_{base}, with the maximum sensitivity enhancement reaching a value of 90. This large sensitivity enhancement can greatly improve the achievable resolution when compared to the linear baseline.

b. Single-Mode Intracavity Absorption Sensing

In this, the theory of single-mode intracavity absorption sensing (SM ICAS) is reviewed. We begin with the rate equations for a laser system. Defining the mean photon number M, the mean population inversion ρ, the broadband cavity loss γ, the pump rate R, the rate of spontaneous decay of the upper laser level A, and the rate of induced emission per photon per excited atom or molecule B, we have:

$$\begin{matrix}\frac{d M}{d t} = - γM + B ρ ( M + 1 ) , \\ \frac{d ρ}{d t} = R - A ρ - ρ B M\end{matrix}$$

The last term in equation (S16a), Bρ, is the mean spontaneous emission rate. This term is often omitted in analysis of single-cavity intracavity absorption sensing. Here, we will give the solutions both with and without this term which will enable discussion of its practical im-portance. Setting both equations to 0 and solving for the steady-state mean photon number gives:

$$M = \frac{1}{2} ( \frac{R}{γ} - \frac{A}{B} ) + \sqrt{\frac{1}{4} {( \frac{R}{γ} - \frac{A}{B} )}^{2} + \frac{R}{γ}}$$

In the case where spontaneous emission is not considered, or when

$${( \frac{R}{γ} - \frac{A}{B} )}^{2} ≫ \frac{R}{γ} ,$$

the last term under the root may be neglected giving:

$$M = \frac{R}{γ} - \frac{A}{B}$$

The intracavity power, Pᵢₙₜ may be found from the mean photon number, M, as

$${P}_{i n t} = ℏ ω \frac{c}{L} M ,$$

where ℏ is the reduced Planck's constant, c is the speed of light, ω is the laser frequency, and we have assumed a free-space cavity of round trip length L. Taking the transmission of the output coupler as T, the output power, Pₒᵤₜ can be found by computing Pₒᵤₜ=TPᵢₙₜ. In terms of equation (S18), then, we have:

$${P}_{o u t} = T {P}_{i n t} = T ℏ ω \frac{c}{L} M = T ℏ ω \frac{c}{L} ( \frac{R}{γ} - \frac{A}{B} ) = ℏ ω \frac{T}{ℒ} ( R - {R}_{t h} ) ,$$

where [symbol] is the total loss, and the relations

$${R}_{t h} = \frac{A γ}{B} and γ = \frac{c ℒ}{L}$$

have been used. As a final manipulation before proceeding, we may also rewrite T=1−R=1−e^{-α}^{_{R}}^{L}≈α_{R}L, where R is the reflection of the output coupler. The total loss, similarly, can be defined as [symbol] =1−e^{-α}^{ₜₒₜ}^{L}≈αₜₒₜL where αₜₒₜ=α_{R}+αₛₐₘₚ+αₒₜₕ is a lumped absorption coefficient which includes the output coupling loss, α_{R}, the loss due to the sample, αₛₐₘₚ, and the loss due to other intracavity elements, αₒₜₕ. Rewriting equation (S19) in terms of these absorption coefficients gives:

$${P}_{o u t} = ℏ ω {α}_{R} ( \frac{R}{{α}_{t o t}} - \frac{c A}{B} ) = ℏ ω \frac{{α}_{R}}{{α}_{t o t}} ( R - {R}_{t h} )$$

To find the enhancement factor according to equation (S9), we seek the quantity ln

$$( \frac{{P}_{o u t} ( {α}_{samp} )}{{P}_{o u t} ( {α}_{samp} + Δ {α}_{samp} )} ) ,$$

where Δαₛₐₘₚ is some small change in the loss due to the presence of an intracavity absorber. Defining ΔPₒᵤₜ=Pₒᵤₜ(αₛₐₘₚ)−Pₒᵤₜ(αₛₐₘₚ+Δαₛₐₘₚ) and assuming

$$\frac{Δ {P}_{o u t}}{{P}_{out}} ≪ 1 ,$$

then ln

$$( \frac{{P}_{o u t} ( {α}_{samp} )}{{P}_{o u t} ( {α}_{samp} + Δ {α}_{samp} )} ) \approx \frac{{P}_{o u t} ( {α}_{samp} ) - {P}_{o u t} ( {α}_{samp} + Δ {α}_{samp} )}{{P}_{o u t} ( {α}_{samp} )} = \frac{Δ {P}_{o u t}}{{P}_{o u t}} .$$

Using (S20), we can find this quantity as:

$$\frac{Δ {P}_{o u t}}{{P}_{o u t}} = \frac{Δ {α}_{s a m p} R}{{α}_{t o t} ( {α}_{t o t} + Δ {α}_{samp} ) ( \frac{R}{{α}_{t o t}} - \frac{c A}{B} )} = \frac{Δ {α}_{samp} N}{( {α}_{t o t} + Δ {α}_{samp} ) ( N - 1 )} ,$$

where we have re-parameterized the system in terms of the number of times above threshold,

$$N = \frac{R}{{R}_{t h}} .$$

Finally, we compute the enhancement

$$ξ = \frac{{L}_{eff}}{L} ,$$

making the approximation that Δαₛₐₘₚ<<αₛₐₘₚ

$$ξ \approx \frac{1}{{α}_{t o t} L} \frac{N}{N - 1}$$

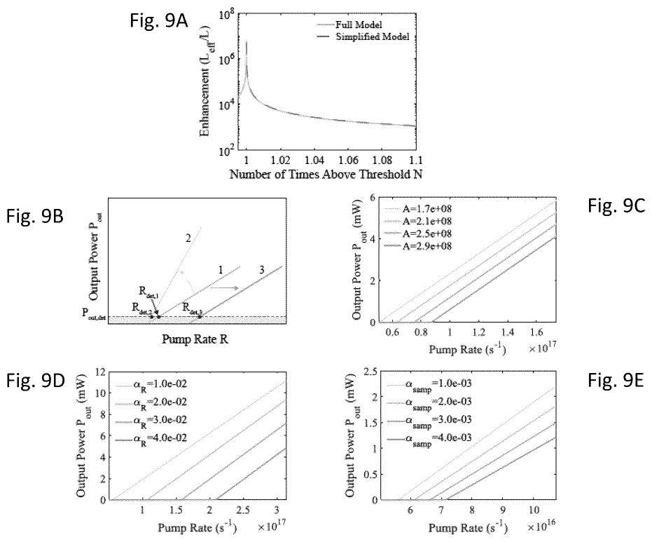

Thus, we see that if spontaneous emission can be neglected, an enhancement asymptotically approaching infinity can be calculated as threshold is approached. FIG. 9a shows the enhancement calculated using the full model from equation (S17) in comparison with the analytic solution ignoring spontaneous emission given by equation (S22) for the realistic laser parameters given in ref. ⁷, namely A=1.7*10⁸ s⁻¹, B=10⁻² s⁻¹, L=1 m, and α_{R}=0.01 m⁻¹. We take the frequency to be ω=4.5*10¹⁴ rad/s, equivalent to the center frequency of our OPO output. For these parameters, the agreement is excellent, with the primary variation occurring extremely near to N=1, where the simplified model asymptotes to infinity while the full model approaches a peak. Generally, agreement is better the lower the spontaneous emission rate.

To maximize the enhancement, then, we would like our system to operate as close to N=1 as possible. However, we face a signal-to-noise ratio (SNR) trade-off in doing so because the signal goes to zero as N approaches 1. Intuitively, there are two ways to improve the situation, as depicted in FIG. 9b. Here, the output power, Pₒᵤₜ, as a function of the pump rate, R, is shown for a reference line (line 1, medium orange) and compared to two modified lines, line 2 in light orange and line 3 in dark orange. The minimum detectable power, P_{out,det}, is shown with the dashed gray line; the shaded gray region below represents photon numbers which cannot be detected. R_{det,i} where i∈{1,2,3} represents the minimum pump rate for which the number of signal photons exceeds P_{out,det}. The first path towards improvement would be to alter the slope efficiency, or the rate of the change of the output power with a changing pump rate above threshold. As shown by line 2, a higher slope efficiency enables operation closer to threshold while maintaining a large enough output power to have a sufficiently large SNR. Alternatively, one can increase the threshold, as exemplified by line 3. For the same slope efficiency and output power, a larger threshold will mean a smaller N; in other words, R_{det,3}/R_{th,3}<R_{det,1}/R_{th,1}. With this intuition, we can then look at the equation (S20) and see how each parameter can help to tune the enhancement. First, we rewrite equation (S20) in terms of P_{out,det}:

$${P}_{out , def} = {α}_{R} ℏ ω ( \frac{R}{{α}_{t o t}} - \frac{c A}{B} )$$

We may then rearrange to solve for R_{det}:

$${R}_{d e t} = {α}_{t o t} ( \frac{c A}{B} + \frac{{P}_{out , det}}{{α}_{R} ℏ ω} )$$

Knowing that

$${R}_{t h} = \frac{{α}_{t o t} c A}{B} ,$$

we find that the detector-limited number of times above threshold, N_{det} is given by:

$${N}_{det} = \frac{{R}_{det}}{{R}_{t h}} = 1 + \frac{B {P}_{out , det}}{{α}_{R} ℏ ω c A}$$

This expression tells us which parameters can be tuned to operate closer to threshold while keeping the signal level the same, thus improving the SNR for a detector-limited measurement. Here, we see clearly that increasing the ratio A/B can help to bring N_{det} closer to 1 while holding the signal constant. This is consistent with FIG. 9c, which shows the output power as a function of the pump rate for varying A. As A is increased, the threshold increases, which should enable operation closer to threshold. With that said, the rates A and B come from fundamental properties of the lasing system and may be difficult to tune in practice. More notable is that the only loss present in equation (S25) is the loss due to the output coupling, α_{R}. A larger output coupling results in a larger extraction efficiency, which increases the threshold and may also benefit the slope efficiency. This is illustrated in FIG. 9d. By contrast, other intracavity loss mechanisms result simultaneously in an increase in the threshold and a decrease in the slope efficiency, as shown in FIG. 9e. The net result is that the two effects cancel one another out, leading to no net gain in terms of operation closer to threshold.

As a final point of comparison, we can find an expression for the sensitivity:

$$S = \vert \frac{\partial {P}_{o u t}}{\partial {α}_{samp}} \vert = {α}_{R} ℏ ω \frac{R}{{α}_{t o t}^{2}}$$

Assuming we are operating at the pump rate given by R_{det}, we find:

$${S}_{det} = {α}_{R} ℏ ω \frac{{R}_{det}}{{α}_{t o t}^{2}} = \frac{{α}_{R} ℏ ω}{{α}_{t o t}} ( \frac{c A}{B} + \frac{{P}_{out , det}}{{α}_{R} ℏ ω} ) ,$$

where S_{det} is the sensitivity at the point dictated by P_{out,det}. As with the SNR for near-threshold operation, we see that the ratio A/B can benefit the absolute sensitivity, further highlighting the benefit of using a laser with a low spontaneous emission rate. Furthermore, we see that the sensitivity is related to αₜₒₜ⁻¹. This suggests the same limitation in dynamic range for ICAS with traditional lasers as we observed for linear methods; for given system parameters, the maximum achievable sensitivity scales with an inverse relationship to the sample loss. Between this relationship and our finding in equation (S22) that the enhancement factor is also inversely related to the loss, it is clear that traditional intracavity absorption sensing with a single-mode laser benefits from a high-finesse cavity and is best suited towards trace gas detection. These conclusions can be used as we analyze the contrasting case of intracavity absorption spectroscopy in a CW OPO in the next section.

c. ICAS in a Continuous-Wave OPO

While the focus of this work is on the simulton regime, which is a pulsed mode of operation, it is desirable also to have a basic analytical framework for understanding ICAS in an OPO. The continuous-wave (CW) theory can give us such a framework, allowing for direct comparison with the general laser case presented above. Specifically, here, we seek to derive the enhancement factor for ICAS in a CW OPO. We additionally derive an expression for the sensitivity, and we see how these quantities scale with critical parameters of the OPO. While such analysis using simulton theory will be the subject of future work, we believe that this CW analysis can provide a starting point for understanding these important behaviors in OPOs.

Our derivation in this section will follow the one presented in ref. ⁸. We begin by deriving an expression for the input-output power relationships, starting with the coupled wave equations for the three-wave mixing process, assuming low loss and low gain. The coupled wave equations for the pump, E₃, signal, E₁, and idler, E₂ electric fields are given by

$$\begin{matrix}\frac{d}{d z} {E}_{1} + \frac{{α}_{1}}{2} {E}_{1} = i {κ}_{1} {E}_{3} {E}_{2}^{*} {e}^{i Δ k z} , \\ \frac{d}{d z} {E}_{2} + \frac{{α}_{2}}{2} {E}_{2} = i {κ}_{2} {E}_{3} {E}_{1}^{*} {e}^{i Δ k z} , \\ \frac{d}{d z} {E}_{3} = i {κ}_{3} {E}_{2} {E}_{1}^{*} {e}^{- i Δ k z} ,\end{matrix}$$

where κᵢ=ωᵢd/nᵢc is the nonlinear coupling coefficient, z is the propagation distance, and αᵢ=μ₀σᵢc is the round trip loss in power, with i∈{1,2,3}. Energy conservation and phase matching require the following relations for the pump, signal, and idler frequencies, ωᵢ, and wave vectors, kᵢ:

$$\begin{matrix}{ω}_{3} = {ω}_{2} + {ω}_{1} \\ {k}_{3} = {k}_{2} + {k}_{1} + Δ k\end{matrix}$$

We will usually achieve a wave-vector mismatch Δk≈0 through quasi-phase matching in the crystal. Next, we make an ansatz for the solution of the coupled wave equations under the assumption of no pump depletion

$$( \frac{d}{d z} {E}_{3} = 0 )$$

to find the gain and bandwidth of a parametric amplifier of length l. Note that this approximation is nearly exact below threshold and thus can be used to accurately estimate the threshold gain of the system.

The ansatz we make is as follows:

$$\begin{matrix}{E}_{1}^{*} ( z ) = {E}_{1}^{*} {e}^{( {Γ}^{′} - i Δ k / 2 ) z} \\ {E}_{2} ( z ) = {E}_{2} {e}^{( {Γ}^{′} - i Δ k / 2 ) z}\end{matrix}$$

Plugging into the coupled wave equations gives:

$$\begin{matrix}{E}_{1}^{*} ( {Γ}^{′} - \frac{1}{2} i Δ k ) = - i {κ}_{1} {E}_{3}^{*} {E}_{2} - {α}_{1} {E}_{1}^{*} \\ {E}_{2} ( {Γ}^{′} - \frac{1}{2} i Δ k ) = - i {κ}_{2} {E}_{3} {E}_{1}^{*} - {α}_{2} {E}_{2}\end{matrix}$$

Substituting for κᵢ and rearranging terms yields:

$$\begin{matrix}{E}_{2} ( {Γ}^{′} + \frac{{α}_{2}}{2} + \frac{1}{2} i Δ k ) + {E}_{1}^{*} ( - \frac{i {ω}_{2} {dE}_{3}}{{n}_{2} c} ) = 0 \\ {E}_{2} ( \frac{i {ω}_{2} {dE}_{3}}{{n}_{2} c} ) + {E}_{1}^{*} ( {Γ}^{′} + \frac{{α}_{2}}{2} - \frac{1}{2} i Δ k ) = 0.\end{matrix}$$

Finally, solving for Γ′ gives:

$${Γ}_{\pm }^{′} = - \frac{( {α}_{1} + {α}_{2} )}{4} \pm {\frac{1}{2} [ \frac{{( {α}_{1} + {α}_{2} )}^{2}}{4} + \frac{i Δ k}{4} ( {α}_{1} + {α}_{2} ) - 4 {( \frac{Δ k}{2} )}^{2} + \frac{4 {ω}_{1} {ω}_{2} \vert d {\vert}^{2} \vert {E}_{3} {\vert}^{2}}{{n}_{1} {n}_{2} {c}^{2}} ]}^{1 / 2} .$$

Thus, we see that Γ′, which is an eigenmode describing the evolution of the field envelopes according to our ansatz, consists of two main terms. The first is a loss term, given by the previously defined round trip losses for the signal and idler. The second term determines the gain, and we see that one eigenmode will grow while the other decays. Setting α₁=α₂=α, we find the simplified expression

$${Γ}_{\pm }^{′} = - \frac{α}{2} \pm g = - \frac{α}{2} \pm \sqrt{{Γ}^{2} - {( \frac{Δ k}{2} )}^{2}} = - \frac{α}{2} \pm \sqrt{\frac{{ω}_{1} {ω}_{2} \vert d {\vert}^{2}}{{n}_{1} {n}_{2} {c}^{2}} {\vert {E}_{3} \vert}^{2} - {( \frac{Δ k}{2} )}^{2}}$$

which gives the following solutions for the signal and idler fields:

$$\begin{matrix}{E}_{1}^{*} ( z ) & ( {E}_{1 +}^{*} {e}^{gz} + {E}_{1 -}^{*} {e}^{- gz} ) {e}^{- \frac{α}{2} z} {e}^{- i Δ kz / 2} \\ {E}_{2} ( z ) & = ( {E}_{2 +} {e}^{gz} + {E}_{2 -} {e}^{- gz} ) {e}^{- \frac{α}{2} z} {e}^{i Δ kz / 2}\end{matrix}$$

Here, g represents the gain for the field and Γ represents the maximum achievable gain, with perfect phase matching. Having arrived at this expression for the evolution of the fields, we now seek to derive the threshold gain of the OPO. By using equations (S31) and (S34) to find expressions for the evolution of the + and − components of the electric fields, we can expand equation (S35) to give the following expressions for E₁(l) and E₂(l), the electric fields at the output of the crystal:

$${E}_{2} ( l ) {e}^{\frac{{α}_{1}}{2} l} = {E}_{1} ( 0 ) {e}^{\frac{i Δ kl}{2}} [ cosh ( gl ) - \frac{i Δ k}{2 g} sinh ( gl ) ] + i \frac{{κ}_{1} {E}_{3}}{g} {E}_{2}^{*} ( 0 ) {e}^{\frac{i Δ kl}{2}} sinh ( gl ) .$$

$${E}_{2} ( l ) {e}^{\frac{{α}_{1}}{2} l} = {E}_{2} ( 0 ) {e}^{\frac{i Δ kl}{2}} [ cosh ( gl ) - \frac{i Δ k}{2 g} sinh ( gl ) ] + i \frac{{κ}_{1} {E}_{3}}{g} {E}_{1}^{*} ( 0 ) {e}^{\frac{i Δ kl}{2}} sinh ( gl ) .$$

With perfect phase matching, we can take Δk=0. Then, assuming small gain, the threshold condition (Eᵢ(l)=Eᵢ(0)) results in the following expression:

$$\begin{matrix}{E}_{1} ( 0 ) {e}^{\frac{{α}_{1}}{2} l} = {E}_{1} ( 0 ) cosh ( Γ l ) + i \frac{{κ}_{1} {E}_{3}}{Γ} {E}_{2}^{*} ( 0 ) sinh ( Γ l ) , \\ {E}_{2} ( 0 ) {e}^{\frac{{α}_{2}}{2} l} = {E}_{2} ( 0 ) cosh ( Γ l ) + i \frac{{κ}_{2} {E}_{3}}{Γ} {E}_{1}^{*} ( 0 ) sinh ( Γ l ) .\end{matrix}$$

Simplifying this system yields:

$$cosh ( Γ l ) = \frac{1 + {e}^{\frac{{α}_{1}}{2} l} {e}^{\frac{{α}_{2}}{2} l}}{{e}^{\frac{{α}_{1}}{2} l} {e}^{\frac{{α}_{2}}{2} l}} \approx 1 + \frac{{α}_{1} l {α}_{2} l}{8 + {α}_{1} l + {α}_{2} l} .$$

If Γl is also small, and α₁l+α₂l<<8, this gives:

$${Γ}^{2} {l}^{2} \approx \frac{{α}_{1} l {α}_{2} l}{4} = \frac{{α}_{1} {α}_{2}}{4}$$

This is the expression for finding the threshold gain of the CW OPO and essentially boils down to a requirement that the gain equal the loss. Now, we derive an approximation for the conversion efficiency of the oscillator. We begin first by deriving the internal efficiency ηᵢₙₜ=(ΔI₁+ΔI₂)/I₃₀ where ΔIᵢ=I_{if}−Iᵢ₀, the change in intensity in a single pass through the gain medium. To accomplish this, we first assume that dE₂/dz and dE₁/dz are negligible (i.e., that the buildup in a single round trip is small), leaving us with the following two equations for the pump wave:

$$\begin{matrix}\frac{d {ε}_{3}^{+}}{dz} = i {κ}_{3} {ε}_{20} {ε}_{10} {e}^{- i ( \frac{1}{2} Δ kz + {ΔΦ}_{+} )} \\ \frac{d {ε}_{3}^{-}}{dz} = - i {κ}_{3} {ε}_{20} {ε}_{10} {e}^{- i ( \frac{1}{2} Δ kz - {ΔΦ}_{-} )}\end{matrix}$$

Here, Eᵢ=εᵢe^{iΦ}^{ᵢ}, and + and − refer to forwards and backwards-propagating fields. Integrating both equations, assuming that the signal and idler fields are independent of z, gives:

$$\begin{matrix}{ε}_{3}^{+} ( l ) = {ε}_{30} + i {κ}_{3} {ε}_{20} {ε}_{10} l sin c ( \frac{1}{2} Δ kl ) {e}^{- i ( \frac{1}{2} Δ kl + {ΔΦ}_{+} )} , \\ {ε}_{3}^{-} ( 0 ) = i {κ}_{3} {ε}_{20} {ε}_{10} l sin c ( \frac{1}{2} Δ kl ) {e}^{i ( \frac{1}{2} Δ kl - {ΔΦ}_{-} )}\end{matrix}$$

From this, we see that maximum energy transfer from the pump to the signal and idler occurs when

$${ΔΦ}_{+} + \frac{1}{2} Δ kl = - \frac{1}{2} π ,$$

which is consistent with the phase matching relationship. Next, we find that, using

$$\frac{1}{{ω}_{1}} \frac{{dI}_{1}}{dz} = \frac{1}{{ω}_{2}} \frac{{dI}_{2}}{dz}$$

and plugging in for the intensities,

$${I}_{i} ( z , ω ) = \frac{1}{2} {n}_{i} c {ϵ}_{0} {\vert {E}_{i} ( z , ω ) \vert}^{2} = \frac{1}{2} {n}_{i} c {ϵ}_{0} {ε}_{i}^{2} ,$$

we can derive the following relation between the signal and idler powers:

$${ε}_{20}^{2} / {ε}_{10}^{2} = {ω}_{2} {n}_{1} {a}_{1} / {ω}_{1} {n}_{2} {a}_{2}$$

The derivation is as follows:

$$\begin{matrix}\frac{{n}_{1} c {ε}_{0}}{2 {ω}_{1}} [ {ε}_{1 f}^{2} - {ε}_{10}^{2} ] = \frac{{n}_{2} c {ε}_{0}}{2 {ω}_{1}} [ {ε}_{2 f}^{2} - {ε}_{20}^{2} ] , \\ \frac{{n}_{1} c {ε}_{0} {α}_{1}}{2 {ω}_{1}} {ε}_{10}^{2} = \frac{{n}_{2} c {ε}_{0} {α}_{2}}{2 {ω}_{1}} {ε}_{20}^{2} , \\ {ε}_{20}^{2} / {ε}_{10}^{2} = {ω}_{2} {n}_{1} {α}_{1} / {ω}_{1} {n}_{2} {α}_{2} .\end{matrix}$$

Between the first and second lines, we have used that ε_{nf}²=εₙ₀²e^{-α}^{ₙ}^{l}≈εₙ₀²−εₙ₀²aₙ. Additionally, conservation of intensity implies:

$${n}_{3} [ {ε}_{30}^{2} - {ε}_{3}^{+ 2} ( l ) - {ε}_{3}^{- 2} ( 0 ) ] = {a}_{2} {n}_{2} {ε}_{20}^{2} + {a}_{1} {n}_{1} {ε}_{10}^{2}$$

This can be solved to give the input-output power relationships. Let us go step by step. First we plug in the expressions (S41a) and (S41b), giving:

$${n}_{3} [ {ε}_{30}^{2} - {ε}_{30}^{2} - i {κ}_{3} {ε}_{30} {ε}_{20} {ε}_{10} l sin c ( \frac{Δ kl}{2} ) {e}^{- i ( \frac{Δ kl}{2} + {ΔΦ}_{+} )} ) + i {κ}_{3} {ε}_{30} {ε}_{20} {ε}_{10} l sin c ( \frac{Δ kl}{2} ) {e}^{i ( \frac{Δ kl}{2} + {ΔΦ}_{+} )} - {κ}_{3}^{2} {ε}_{20}^{2} {ε}_{10}^{2} {l}^{2} sin {c}^{2} ( \frac{Δ kl}{2} ) - {κ}_{3}^{2} {ε}_{20}^{2} {ε}_{10}^{2} {l}^{2} sin {c}^{2} ( \frac{Δ kl}{2} ) ] = {a}_{2} {n}_{2} {ε}_{20}^{2} + {a}_{1} {n}_{1} {ε}_{10}^{2}$$

The first two terms on the left-hand side cancel out, the next two terms can be combined into a single sine term, and the last two terms are the same and can thus be joined. Once this is done, we use expression (S42) to re-express everything in terms of ε₂₀ and ε₃₀:

$${n}_{3} [ - 2 {κ}_{3} {ε}_{30} {ε}_{20}^{2} \sqrt{\frac{{ω}_{1} {n}_{2} {a}_{2}}{{ω}_{2} {n}_{1} {a}_{1}}} l sin c ( \frac{Δ kl}{2} ) sin ( \frac{Δ kl}{2} + {ΔΦ}_{+} ) - {κ}_{3}^{2} {ε}_{20}^{4} \frac{{ω}_{1} {n}_{2} {a}_{2}}{{ω}_{2} {n}_{1} {a}_{1}} {l}^{2} sin {c}^{2} ( \frac{Δ kl}{2} ) ] = {a}_{2} {n}_{2} {ε}_{20}^{2} \frac{{ω}_{3}}{{ω}_{2}}$$

Next, we can divide by the right-hand side, rearrange the terms, and plug in for κ₃ and intensities to find:

$${a}_{2} \frac{{ω}_{3} {I}_{20}}{{ω}_{2} {I}_{30}} sin {c}^{2} ( \frac{Δ kl}{2} ) = \frac{2 {I}_{3 , th}}{{I}_{30}} [ \sqrt{\frac{{I}_{30}}{{I}_{3 , th}}} sin c ( \frac{Δ kl}{2} ) - 1 ]$$

We have defined the threshold intensity

$${I}_{3 , th} = \frac{{n}_{1} {n}_{2} {n}_{3} {α}_{1} {α}_{2} {c}^{3} {ε}_{0}}{8 {ω}_{1} {ω}_{2} {\vert d \vert}^{2}} ,$$

consistent with equation (S39), our earlier expression for the threshold gain. Note that an equivalent expression can be derived in terms of l₁₀ by following the same steps. Finally, this gives, assuming Δk=0 and realizing that ΔI₂≈a₂I₂₀:

$$\frac{{ω}_{3}}{{ω}_{2}} \frac{Δ {I}_{2}}{{I}_{30}} = \frac{{ω}_{3}}{{ω}_{1}} \frac{Δ {I}_{1}}{{I}_{30}} = \frac{2}{N} [ \sqrt{N} - 1 ]$$

Here, we have defined the quantity N=I₃₀/I_{3,th}. Then, combining the two expressions, the internal efficiency is:

$${η}_{int} = \frac{Δ {I}_{1} + Δ {I}_{2}}{{I}_{30}} = \frac{2}{N} [ \sqrt{N} - 1 ]$$

This defines the internal efficiency of a CWOPO at N times above threshold, accounting for both the forwards and backwards-propagating waves. Since our OPO is a a ring-resonant oscillator, however, the backwards wave does not interact with the gain medium, so its contribution may be ignored. The result of repeating the calculation without this final term in equation (S42) is an additional factor of two in the final expression:

$${η}_{int} = \frac{Δ {I}_{1} + Δ {I}_{2}}{{I}_{30}} = \frac{4}{N} [ \sqrt{N} - 1 ] .$$

Next, we must find the extraction efficiency, next, which characterizes the ratio of the generated signal and idler intensity in the OPO to the OPO output. As before, we will calculate it just for the idler and infer that the signal should behave similarly. Let us assume that the outcoupling of our resonator at the idler is T₂, in intensity. Note that we have been implicitly including this outcoupling in the round trip loss parameter, but here we separately define the outcoupling in order to explicitly refer to it.

Assuming the total internal intensity in the resonator is I_{2,int}, the output intensity is then I_{2,out}=T₂I_{2, int}. Each round trip, I_{2, int} grows by the above calculated quantity, ΔI₂, and is depleted by the quantity

$${I}_{2 , int} {e}^{- {α}_{2} l} .$$

From this, we see that the internal intensity is given by the infinite sum:

$${I}_{2 , int} = Δ {I}_{2} {\sum }_{n = 0}^{∞} {( {e}^{- {α}_{2} l} )}^{n} = \frac{Δ {I}_{2}}{1 - {e}^{- {α}_{2} l}} .$$

Then, we see that the output power is given by:

$${I}_{2 , out} = \frac{{T}_{2} Δ {I}_{2}}{1 - {e}^{- {α}_{2} l}}$$

Thus, the extraction efficiency is:

$${η}_{ext , 2} = \frac{{T}_{2}}{1 - {e}^{- {α}_{2} l}} \approx \frac{{T}_{2}}{{α}_{2} l}$$

An equivalent expression can be derived for the signal. Finally, the conversion efficiencies for the signal, η₁=η_{int,1}η_{ext,1}, and idler, η₂=η_{int,2}η_{ext,2}, are found to be:

$$\begin{matrix}{η}_{1} = \frac{{I}_{1 , out}}{{I}_{30}} = \frac{{T}_{1}}{{α}_{1} l} \frac{{ω}_{1}}{{ω}_{3}} \frac{2}{N} [ \sqrt{N} - 1 ] , \\ {η}_{2} = \frac{{I}_{2 , out}}{{I}_{30}} = \frac{{T}_{2}}{{α}_{2} l} \frac{{ω}_{2}}{{ω}_{3}} \frac{2}{N} [ \sqrt{N} - 1 ] .\end{matrix}$$

The total conversion efficiency is the sum of the two:

$$η = \frac{{I}_{1 , out} + {I}_{2 , out}}{{I}_{30}} = ( \frac{{T}_{2}}{{α}_{2} l} \frac{{ω}_{2}}{{ω}_{3}} + \frac{{T}_{1}}{{α}_{1} l} \frac{{ω}_{1}}{{ω}_{3}} ) \frac{2}{N} [ \sqrt{N} - 1 ] .$$

We now wish to utilize this expression for conversion efficiency to study the relationship between the loss and the output power of the system. We also will be looking at the degenerate case, where ω₁=ω₂=ω. For notational clarity, we will redefine I_{1, out}+I_{2, out}=I_{ω, out}, the degenerate signal, and I₃ as I_{2ω}, the degenerate pump, and we will use the same for subscripts on all other quantities. Then, we have the following expression for the signal:

$${I}_{ω , out} = \frac{T}{{α}_{ω} l} \frac{2 {I}_{2 ω , 0}}{N} [ \sqrt{N} - 1 ] = \frac{T}{{α}_{ω} l} \frac{{n}_{ω}^{2} {n}_{2 ω} {α}_{ω}^{2} {c}^{3} {ε}_{0}}{4 {ω}^{2} \vert d {\vert}^{2}} [ \sqrt{\frac{8 {ω}^{2} {\vert d \vert}^{2} {I}_{2 ω , 0}}{{n}_{ω}^{2} {n}_{2 ω} {α}_{ω}^{2} {c}^{3} {ε}_{0}} - 1} ] = \frac{T}{l} \sqrt{\frac{{n}_{ω}^{2} {n}_{2 ω} {c}^{3} {ε}_{0}}{2 {ω}^{2} \vert d {\vert}^{2}}} [ \sqrt{{I}_{2 ω , 0}} - {α}_{ω} \sqrt{\frac{{n}_{ω}^{2} {n}_{2 ω} {c}^{3} {ε}_{0}}{8 {ω}^{2} \vert d {\vert}^{2}} ] .}$$

This expression can allow us to characterize the OPO behavior in the case of single-mode ICAS. First, we look at the enhancement factor. For a small change in the loss, Δα_{ω}, we have the following change in signal:

$$Δ {I}_{ω , o u t} = \frac{T}{l} \frac{{n}_{ω}^{2} {n}_{2 ω} Δ {α}_{ω} {c}^{3} {ε}_{0}}{4 {ω}^{2} {\vert d \vert}^{2}}$$

Then, the enhancement

$$ξ = \frac{Δ {I}_{ω , out}}{l Δ {α}_{ω} {I}_{ω , out}}$$

is given by:

$$ξ = \frac{1}{l {α}_{ω}} \frac{1}{\sqrt{N} - 1}$$

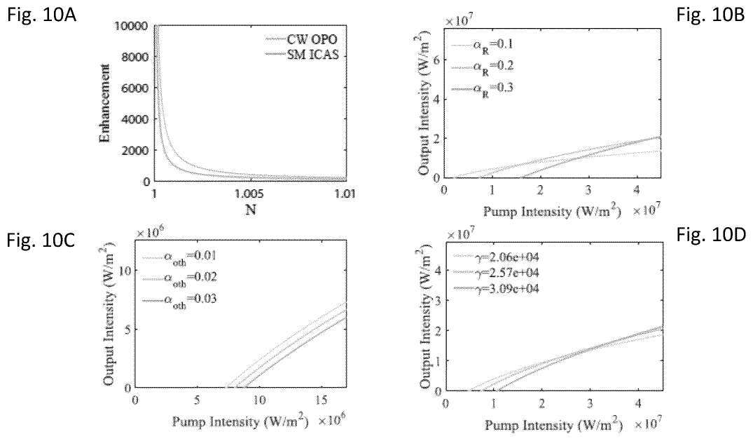

This is a very similar behavior as the one predicted by the SM laser theory. However, one advantage of the OPO according to this result is the \sqrt{N}−1 behavior in the denominator which grows to large values further away from threshold than the N−1 behavior exhibited in the SM laser case, as illustrated in FIG. 10a. Here, we see that the CW OPO (orange) grows more quickly as N=1 is approached when compared to SM ICAS (pink).

In addition to the enhancement, we may also look at the other scaling behaviors of the CW OPO system, as we did in the case of SM ICAS. Firstly, let us make some simplifications. To begin, we return to our earlier observation that the output coupling has been included implicitly in the loss; in fact, the loss α_{ω} consists of three components such that α_{ω}=αₛₐₘₚ+α_{R}+αₒₜₕ. Here, αₛₐₘₚ is the loss from the sample of interest, α_{R} is the loss from the output coupling such that the reflection R=e^{-α}^{_{R}}^{l}, and αₒₜₕ accounts for all other round trip losses in the OPO cavity. Then, T=1−R=1−e^{-α}^{_{R}}^{l}≈α_{R}l. Furthermore, we define the parameter

$$γ = \sqrt{\frac{{n}_{ω}^{2} {n}_{2 ω} {c}^{3} {ε}_{0}}{2 {ω}^{2} {\vert d \vert}^{2}}} ,$$

giving:

$${I}_{ω , o u t} = {α}_{R} γ [ \sqrt{{I}_{2 ω , 0}} - \frac{{α}_{ω} γ}{2} ]$$

Let us now define a detector-limited output intensity, I_{ω,det}. The corresponding input intensity, I_{2ω,det}, is:

$${I}_{2 ω , det} = {( \frac{{I}_{ω , det}}{{α}_{R} γ} + \frac{{α}_{ω} γ}{2} )}^{2} = \frac{{I}_{ω , det}^{2}}{{α}_{R}^{2} {γ}^{2}} + \frac{{I}_{ω , det} {α}_{ω}}{{α}_{R}} + \frac{{α}_{ω}^{2} {γ}^{2}}{4}$$

Using this, and noting that the threshold intensity is

$${I}_{2 ω , t h} = \frac{{α}_{ω}^{2} {γ}^{2}}{4} ,$$

we find the number of times above threshold needed to achieve an output intensity of I_{ω, det}, N_{det}, is: a

$${N}_{det} = 1 + \frac{4 {I}_{ω , det}^{2}}{{α}_{R}^{2} {α}_{ω}^{2} {γ}^{4}} + \frac{4 {I}_{ω , det}}{{α}_{R} {α}_{ω} {γ}^{2}} .$$

Here we see that, unlike the SM laser case, the number of times above threshold for the OPO can be brought closer to 1 through tuning of the loss. This is a result of the loss contributing to the threshold directly through the offset term in the OPO case rather than through the slope, as it did in the case of the SM laser. Additionally, we see that tuning of the output coupling can provide the largest benefit, since it serves to simultaneously increase the slope efficiency and threshold. Finally, increasing γ can also be used to improve the detector-limited sensitivity enhancement, with a benefit similar to that of the output coupling. These observations are consistent with the scaling behaviors of equation (S55), plotted in FIGS. 10b, 10c, and 10d for variation in the output coupling, loss, and γ parameter, respectively. The output coupling and γ parameter can both be tuned to simultaneously increase the threshold and slope efficiency, while increasing the round trip loss can increase the threshold without impacting the slope efficiency.

In addition to looking at the detector-limited enhancement, we can compute the sensitivity, which is given here as:

$$S = \vert \frac{\partial {I}_{o m e g a , o u t}}{\partial {α}_{s a m p}} \vert = {α}_{R} \frac{{γ}^{2}}{2} .$$

Again, there is a notable difference as compared to the SM laser case. Specifically, the loss term due to the sample does not appear anywhere in the equation. However, both the output coupling and γ parameter can be increased to improve the sensitivity, consistent with what we saw in equation (S57) for the detector-limited enhancement. These results suggest that, unlike the SM laser case, the CW OPO can benefit from operation in the low-finesse regime, provided there is sufficient gain to go above threshold. Additionally, this lack of dependence on the sample loss allows for a high dynamic range to be achieved for sensing measurements performed in the OPO system. These differences arise due to the different gain mechanisms of the two systems as represented in their respective rate equations, where the laser gain arises from an energy exchange in which an atomic transition results in emission of a photon while the parametric gain comes from an interaction between the pump and signal electric fields through the quadratic nonlinearity. Although understanding the simulton behavior requires a more careful treatment than the CW model, these observations are consistent with our experimental findings and give further insight into why the high threshold and slope efficiency of the simulton can provide large sensitivity enhancement as well as why we are able to achieve a large dynamic range in our measurement.

d. Simulton Theory

The simulton is a co-propagating bright-dark soliton pair in the signal at frequency ω and the pump at 2ω, respectively. The simulton solution can be readily found for a traveling wave optical parametric amplifier (OPA) operating at degeneracy by considering the coupled wave equations, keeping only the walk-off and nonlinear coupling terms. In this section, we derive the simulton solution following the notation of ref. ⁹ and utilize the analytic expressions for its dynamical evolution to provide intuition for the presented sensing mechanism. We begin with the coupled wave equations for the fields at degeneracy:

$$\frac{\partial }{\partial z} {E}_{ω} ( z , t ) = κ {E}_{2 ω} {E}_{ω}^{*} ,$$

$$\frac{\partial }{\partial z} {E}_{2 ω} ( z , t ) = - {Δβ}^{′} \frac{\partial }{\partial t} {E}_{2 ω} - κ {E}_{ω}^{2} .$$

Here, κ is the nonlinear coupling coefficient, Δβ′ is the group velocity mismatch, and E_{ω} and E_{2ω} refer to the signal and pump fields, respectively. The time coordinate is defined to be co-moving with the group velocity of the signal wave. Assuming wave solutions of the form E_{ω}(z, t)=E_{ω}(t+vz) and E_{2ω}=E_{2ω}(t+νz) with inverse group velocity ν gives:

$$ν \frac{\partial }{\partial t} {E}_{ω} ( z , t ) = κ {E}_{2 ω} {E}_{ω}^{*}$$

$$( ν + {Δβ}^{′} ) \frac{\partial }{\partial z} {E}_{2 ω} ( z , t ) = - κ {E}_{ω}^{2}$$

This system of equations can be solved analytically to yield the simulton solution:

$${E}_{ω} ( z , t ) = \frac{a}{\sqrt{2 τ}} sech ( \frac{t - T}{τ} )$$

$${E}_{2 ω} ( z , t ) = - {E}_{2 ω , 0} tanh ( \frac{t - T}{τ} )$$

In these equations, we have re-parameterized the system in terms of τ, the signal pulse duration, T, the timing advance experienced due to gain saturation, E_{2ω,0}, the pump amplitude, and a, the simulton signal amplitude. Defining the small-signal gain coefficient, γ₀=κE_{2ω,0}, we find that

$${a}^{2} = \frac{2 {γ}_{0}}{{κ}^{2}} ( {Δβ}^{′} + {γ}_{0} τ )$$

### and T=−γ₀τz

Thus, we see that the simulton consists of a tanh-shaped dark soliton in the pump and sechshaped bright soliton in the signal which are co-moving with a group velocity greater than the signal group velocity by a factor ν=γ₀τ. Now, we wish to extend this solution to the dynamical regime where we can understand the impact of gain and loss on the system, following the manifold projection method presented in ref. ¹⁰. We begin again with the coupled wave equations and use the method of characteristics to derive a solution for the pump field. We have:

$$\frac{\partial {E}_{2 ω} ( z , t )}{\partial z} + {Δβ}^{′} \frac{\partial {E}_{2 ω} ( z , t )}{\partial t} = - κ {E}_{ω}^{2} ( z , t )$$

Solving for E_{2ω} gives:

$${E}_{2 ω} ( z , t ) = {E}_{2 ω} ( 0 , t - {Δβ}^{′} z ) - κ {\int }_{0}^{z} {E}_{ω}^{2} ( {z}^{′} , t + {Δβ}^{′} ( {z}^{′} - z ) ) {dz}^{′}$$

To simplify the integral, we make the change of variables t′=t+Δβ′(z′−z), giving:

$${E}_{2 ω} ( z , t ) = {E}_{2 ω} ( 0 , t - {Δβ}^{′} z ) - \frac{κ}{{Δβ}^{′}} {\int }_{t - {Δβ}^{′} z}^{t} {E}_{ω}^{2} ( z , {t}^{′} ) {dt}^{′}$$

Now, we invoke the gain without distortion assumption, which says generally that E_{ω}(z,t)≈e^{γ}^{ₐᵥ}^{z}Ē_{ω}(z, t) such that Ē_{ω}(z, t) is slowly varying in z and γₐᵥ satisfies re^{γ}^{ₐᵥ}^{l}=1 for an OPO cavity with mirror reflectivity r and crystal length l. Under the present change of variables, this gives

$${E}_{ω} ( z , {t}^{′} ) \approx {e}^{\frac{γ av}{{Δβ}^{′}} ( {t}^{′} - t )} {\overline{E}}_{ω} ( z , {t}^{′} )$$

Noticing that the primary variation in the signal comes from this exponential term and thus vanishes exceedingly fast for increasingly negative t′, we can assume the lower limit of the integral extends to −∞ to good approximation:

$${E}_{2 ω} ( z , t ) = {E}_{2 ω} ( 0 , t - {Δβ}^{′} z ) - \frac{κ}{{Δβ}^{′}} {\int }_{- ∞}^{t} {E}_{ω}^{2} ( z , {t}^{′} ) {dt}^{′}$$

Next, we can plug this expression for the pump into (S59a), the differential equation describing the evolution of the signal. This yields:

$$\frac{\partial {E}_{ω} ( z , t )}{\partial z} = κ {E}_{ω} ( z , t ) {E}_{2 ω} ( 0 , t - {Δβ}^{′} z ) - \frac{{κ}^{2}}{{Δβ}^{′}} {E}_{ω} ( z , t ) {\int }_{- ∞}^{t} {E}_{ω}^{2} ( z , {t}^{′} ) {dt}^{′}$$

From here, we assume the field envelope takes on the sech-like form given above for the simulton, but we allow the parameters T, τ, and a to vary in z:

$${E}_{sim} ( z , t ) = \frac{a ( z )}{\sqrt{2 τ ( z )}} sech ( \frac{t - T ( z )}{τ ( z )} ) .$$

Plugging this into equation (S66) for E_{ω}(z, t) and assuming a constant pump, E_{2ω,0}, gives:

$$\frac{\partial {E}_{ω} ( z , t )}{\partial z} = κ {E}_{2 ω , 0} \frac{a ( z )}{\sqrt{2 τ ( z )}} sech ( \frac{t - T ( z )}{τ ( z )} ) - \frac{{κ}^{2} {a}^{2} ( z )}{2 {Δβ}^{′} \sqrt{2 τ ( z )}} sech ( \frac{t - T ( z )}{τ ( z )} ) [ tanh ( \frac{t - T ( z )}{τ ( z )} ) + 1 ] .$$

Defining the right-hand side of equation (S68) as g(z, t), we now perform the manifold projection to obtain equations for the evolution of the signal pulse parameters. To perform the projection, we must first define an inner product, which we take to be [symbol] f|g [symbol] =∫f(t)g(t)dt. The full derivative of Eₛᵢₘ with respect to z is given by:

$$\frac{{dE}_{sim}}{dz} = \frac{\partial {E}_{sim}}{\partial T} \frac{dT}{dz} + \frac{\partial {E}_{sim}}{\partial τ} \frac{d τ}{dz} + \frac{\partial {E}_{sim}}{\partial a} \frac{da}{dz} .$$

Letting

$$\frac{{dE}_{sim}}{dz} = g ( z , t ) ,$$

and using the orthogonality of the partial derivatives under the defined inner product,

$$e . g . 〈 \frac{\partial {E}_{sim}}{\partial ξ} \vert \frac{\partial {E}_{sim}}{\partial η} 〉 = 0$$

where ξ, η∈{T, τ,a} and ξ≠η, we find the following expression for the evolution of parameter ξ:

$$\frac{\partial ξ}{\partial z} = \frac{\int g ( z , t ) \frac{\partial {E}_{sim}}{\partial ξ} dt}{\int \frac{\partial {E}_{sim}^{2}}{\partial ξ} dt}$$

Applying this to our three parameters of interest gives the following system of equations for their evolution:

$$\frac{\partial T}{\partial z} = - {γ}_{0} τ \frac{{a}^{2}}{{a}_{sim}^{2}} , \\ \frac{\partial τ}{\partial z} = 0 , \\ \frac{\partial a}{\partial z} = {γ}_{0} a ( 1 - \frac{{a}^{2}}{{a}_{sim}^{2}} ) .$$

Here, aₛᵢₘ is the steady-state simulton amplitude, given by

$${a}_{sim}^{2} = \frac{2 {γ}_{0} {Δβ}^{′}}{{κ}^{2}} .$$

This system of equations can be solved analytically to yield steady-state solutions for T, τ, and a, giving:

$$T ( z ) = {τ}_{0} ln ( \frac{a ( z )}{a ( 0 ) {e}^{{γ}_{0} z}} ) + T ( 0 ) , \\ τ ( z ) = {τ}_{0} \\ a ( z ) = \frac{a ( 0 ) {e}^{{γ}_{0} z}}{\sqrt{1 + \frac{{a ( 0 )}^{2}}{{a}_{sim}^{2}} ( {e}^{2 {γ}_{0} z} - 1 )}} .$$

We may now consider the effects of loss and detuning on the system. Let us consider a round trip delay of ΔT_{RT} and a round trip loss of Re^{-αL} where R is the lumped mirror reflection in the round trip and a accounts for additional losses in the round trip propagation, including due to the presence of an intracavity sample, for the resonator of total length L. Assuming the nonlinear crystal is length l, we get for the round trip evolution that:

$$T ( n + 1 ) = {τ}_{0} ln ( \frac{a ( l )}{a ( n ) {e}^{{γ}_{0} l}} ) + T ( n ) + Δ {T}_{RT} , \\ τ ( n + 1 ) = {τ}_{0} , \\ a ( n + 1 ) = \frac{a ( n ) {Re}^{{γ}_{0} l - α L}}{\sqrt{1 + \frac{{a ( n )}^{2}}{{a}_{sim}^{2}} ( {e}^{2 {γ}_{0} l} - 1 )}} .$$

Steady-state is reached when T(n+1)=T(n) and a(n+1)=a(n). From this, we can see the two requirements for simulton formation: the gain must equal the loss such that Re^{γ}^{₀}^{l-αL}=1 and the simulton group advance must compensate the detuning, meaning τ₀ln

$$( \frac{a ( L )}{a ( 0 ) {e}^{{γ}_{0} L} )} = - Δ {T}_{RT} .$$

Additionally, we see the interdependence of the two conditions, as the steady-state centroid position T depends on how quickly the simulton amplitude a saturates to its steadystate value. Since the growth of the amplitude depends on the interplay of gain and loss, the steady-state centroid position is therefore ultimately dictated by the gain and loss of the system. While here we have approximated the pump as continuous, this interplay becomes very important for a pulsed pump, where the pump defines a temporal gain window for the signal. In this case, the bright soliton in the signal cannot go above threshold if its amplitude does not grow quickly enough to satisfy the timing condition before the detuning pulls it out of the gain window. Above threshold, it will experience more or less gain depending on its steadystate position within the gain window. These dynamics, as illustrated in FIG. 1d and FIG. 3c, are what cause the high slope efficiency for the simulton near threshold and, correspondingly, the high sensitivity of the simulton to the addition of sample to the cavity.

### Fourth Example: Performing Spectroscopy with OPOs

In various examples, the OPO sensor can be constructed using either a doubly resonant OPO (DRO) or a singly resonant OPO (SRO), with slightly different sensing mechanisms. In a DRO, both the signal and the idler resonate whereas in an SRO, only one of the signal or the idler resonates. Although the threshold for a DRO can be much lower than that of a SRO, the necessary overlapping of signal and idler resonances place tolerance limits on cavity length and pump-frequency fluctuations [1]. Resonating only the signal (or idler) allows SROs to achieve better output power stability and a wider frequency tuning range.

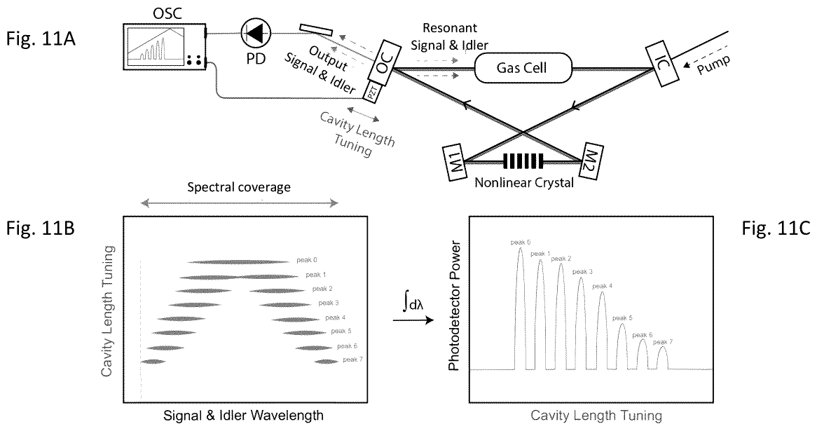

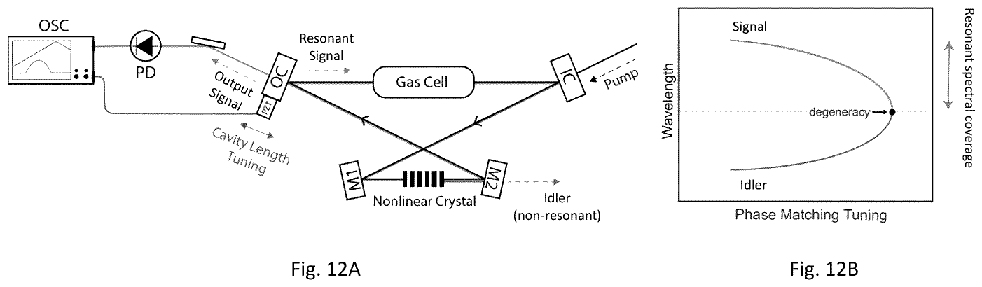

First consider a DRO sensor illustrated in FIG. 11a below, where the cavity and mirrors are designed so that both the signal and the idler are resonating inside the cavity. The output power is measured by a single photodetector at the output of the SRO, and we can monitor the output power as a function of OPO tuning parameters such as cavity length. As shown in FIG. 11b, each OPO peak has a different spectral profile. As we continuously scan the cavity length of the SRO, the output power time trace (FIG. 11c) can allow us to partially reconstruct the intracavity absorption spectrum. For instance, if an absorption feature of some target molecule only overlaps with mode 0 and mode 7 in FIG. 11b, it would be reflected as a decrease in photodetector power only on the peaks associated with modes 0 and 7. Engineering the overall spectral coverage and spectral overlaps between different cavity modes can allow effective spectral reconstruction using only the photodetector signal.

Next consider the SRO illustrated in FIG. 12a where only the signal (orange) is resonating inside the cavity, but not the idler (green) or the pump. The signal power is still measured by a single photodetector at the output of the SRO. At some arbitrary signal frequency, if we monitor the output power as a function of cavity length, we do not see the discrete OPO peaks as in the case of a DRO. Instead, the output signal frequency can be changed by tuning the phase matching (through temperature tuning of the crystal, for example), effectively turning the SRO into a narrow linewidth, tunable source. As an example, pumping an SRO with a near-IR wavelength can allow signal tuning further into the mid-IR spectral regions.

Alternatively, instead of directly monitoring the mid-IR signal wavelength at the OPO output, we can also only measure the non-resonant near-IR idler, as the absorption features on the signal are also imprinted on the idler. Measuring the idler allows the signal to resonate with higher Q, as well as enabling mid-IR sensing using near-IR sources and detectors.

The frequency tuning of an SRO sensor is shown in FIG. 12b, where the curve represents signal and idler wavelengths at some fixed pump frequency. The degeneracy point corresponds to when the signal and idler wavelengths are equal. As we tune the phase matching, the signal wavelength changes and overlaps with different absorption features of the target molecule inside the gas cell. The absorptions within the spectral coverage of the signal wavelength are further enhanced by resonance, enabling intracavity sensing. Reading the output signal power as a function of phase matching tuning would allow effective spectral reconstruction without using a spectrometer.

In one or more embodiments for singly-resonant oscillators, either the signal or idler can be resonant and any of the pump, the small outcoupled resonant beam or the non-resonant beam can be measured on the photodetector.

### Process Steps

a. Method of Fabrication

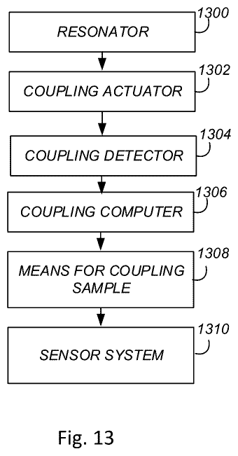

FIG. 13 is a flowchart illustrating a method of making a sensor system. The method comprises the following steps.

Block 130 represents providing a resonator comprising a nonlinear material comprising a nonlinear susceptibility configured to convert a pump electromagnetic wave (EM) wave to a signal EM wave and an idler EM wave, wherein at least one of the pump EM wave, the signal EM wave and/or the idler photon is fed back through the nonlinear material to form one or more resonant EM waves.

Block 1302 represents coupling an actuator to the resonator or a pump path to the resonator, for modulating at least one of a pump power of the pump EM wave, a detuning of the frequency modes of the resonator relative to one or more frequencies of the resonant EM waves, or a phase matching of the nonlinear material. The actuator can comprise or be coupled to a computer or one or more circuits outputting signals used to control the actuator.

Block 1304 represents optionally coupling a detector (e.g., photodetector) to an output of the resonator, for detecting one or more output EM waves comprising information about a sample coupled to the resonator.

Block 1306 represents optionally coupling a computer to the detector.

Block 1308 represents optionally coupling means for coupling sample.

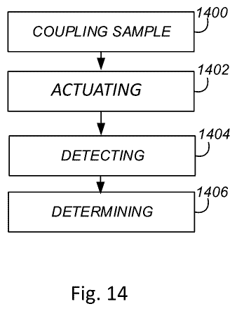

Block 1310 represents the end result, a sensor or sensor system. The sensor can be embodied in many ways including, but not limited to, the following examples (referring also to FIGS. 1-16.

1. A sensor 100, comprising:
a resonator 102 comprising a nonlinear material 130, 302 comprising a nonlinear susceptibility configured to convert a pump electromagnetic wave (EM) wave 106 to a signal EM wave 108 and an idler EM wave 110, wherein at least one of the pump EM wave, the signal EM wave and/or the idler EM wave is fed back through the nonlinear material to form one or more resonant EM waves 111;
an actuator 104 coupled to the resonator or a pump path to the resonator, for controlling or modulating at least one of a pump power of the pump EM wave, a detuning of the frequency modes of the resonator relative to one or more frequencies of the resonant EM waves, or a phase matching of the nonlinear material; and
an output 120 of the resonator, for outputting one or more output EM waves 122 comprising information about a sample 116 coupled to the resonator.

2. The sensor of example 1, further comprising:
a detector 112 coupled to the output of the resonator, for detecting an output power of the one or more output EM waves; and
a computer 114 coupled to the detector, wherein the computer is configured to determine the information about the sample from a change in the output power when the resonant EM waves are coupled to the sample.

3. The sensor of example 2, wherein the computer is configured to:
determine the information by comparing the output power to a calculated output power calculated using a model of a response of the resonator coupled to the sample interacting with the resonant EM waves and/or,
determine the information using a machine learning algorithm trained using training data, wherein:
the training data comprises an association between:
a concentration or composition of the sample, and
the output power as a function of at least one of the pump power, the detuning, or the phase matching, and/or
determines the information by only analyzing the change in the output power.

4. The sensor of any of the examples 1-3, further comprising an optical parametric oscillator (OPO) 118, 302 comprising the resonator.

5. The sensor of example 4, wherein the OPO is configurable to operate at a phase transition between degenerate and non-degenerate operation.

6. The sensor of example 4, wherein the OPO 302 is configurable to:
operate near threshold for lasing of the resonant EM waves, and
the EM comprise simultons,
so that a sensitivity of the sensor to a change in the sample is enhanced by near-threshold dynamics such as simulton or other soliton formation mechanisms.

7. The sensor of any of the examples 4-6, wherein the actuator is configured to change operation of the OPO from below a threshold (for lasing of the resonant EM waves) to above the threshold.

8. The sensor of any of the examples 1, wherein the resonator operates near oscillation threshold for lasing of the resonant EM waves, as characterized by 0.9≤pump power/threshold pump power≤3 (e.g., ˜1) or
the actuator sets the detuning or the phase matching so that the resonator operates at least at a spectral phase transition between degenerate and non-degenerate operation and/or the resonant EM waves comprise simultons.

9. The sensor of any of the examples 1-8, wherein the actuator 104 causes the resonant EM waves in the resonator to follow a predictable spectral tuning and the output EM waves can be used to reconstruct the function of a tunable laser spectrometer.

10. The sensor of any of the examples 1-9, wherein the actuator 104 is configured to modulate at least one of the pump power, the detuning, or the phase matching to tune a dynamic range, sensitivity, or selectivity of the sensor.

11. The sensor of any of the examples 1-10, wherein the information comprises at least a concentration or a composition differentiation of the sample comprising one or more molecules, one or more molecular species, or one or more compounds.

12. The sensor of any of the examples 1-11, wherein the information comprises a physical or chemical property of the sample comprising a solid, liquid, or gas.

13. The sensor of any of the examples 1-12, wherein the information is outputted in real time with a change in the sample and with a temporal resolution limited by a modulation/actuation speed of the actuator and acquisition time of the information (e.g., 1 Hz-1 MHz).

14. The sensor of any of the examples 1-13, wherein the actuator comprises at least one of an actuator configured to tune a length of the resonator, a heater or cooler thermally coupled to the resonator for modulating the phase matching and/or the length of the resonator, an electro-optic modulator capable of tuning a refractive index of a path length in the cavity, an electro-optic mirror or beamsplitter for controlling a power of the pump EM wave, or a control circuit coupled to a pump source for tuning a frequency or power of the pump EM wave outputted from the pump source.

15. The sensor of any of the examples 1-14, wherein the actuator comprises a scanner applying one or more ramp functions modulating at least one of the pump power, the detuning, or the phase matching.

16. One or more chips or photonic integrated circuits comprising the sensor or the resonator of any of the examples 1-15, or an array of the resonators of any of the examples 1-15.

17. The sensor of any of the examples 1-16, further comprising means for making the resonant EM wave of the resonator interact with the sample, wherein the means comprises a sample container positioned to couple the sample to the resonator through an evanescent field, a slot waveguide, an optical fiber, a chamber in the resonator, a fluidic coupling, a free space coupling, or a hollow core fiber.

18. The sensor of any of the examples 1-17, wherein:
the resonator comprises a cavity comprising the nonlinear material between mirrors, and the cavity comprises a sample space for positioning the sample within the cavity.

19. The sensor of any of the examples 1-18, wherein the resonator comprises an optical fiber loop coupled to the nonlinear material.

20. An analyzer comprising the sensor of any of the examples 1-19 configured for outputting the information about the sample comprising breath, an atmospheric concentration of a pollutant or greenhouse gas, or a process gas monitored in an industrial setting.

21. The sensor of any of the examples 1-20, wherein the information comprises a concentration of the sample in a range (e.g., of part per trillion volume to several precents) causing saturation a linear absorption sensor according to the Beer Lambert Law.

22. The sensor of any of the examples 1-21, wherein the modulation causes tuning of a narrow linewidth spectrum.

23. The sensor of any of the examples 1-22, wherein the nonlinear materials are phase matched, dispersion engineered, and/or have a length L tailored for the second order parametric amplification/conversion processes converting the pump wave to the signal wave and the idler wave, and/or achieve non-degenerate operation, degenerate operation, near threshold operation or other operation modes and regime described in the examples.

24. A method of sensing, comprising:
coupling a sample to a resonator comprising a nonlinear material comprising a nonlinear susceptibility configured to convert a pump electromagnetic (EM) wave to a signal EM wave and an idler EM wave, wherein at least one of the pump EM wave, the signal EM wave or the idler EM wave is fed back through the nonlinear material to form one or more resonant EM wave;
controlling at least one of a pump power of the pump EM wave, a detuning of the frequency modes of the resonator relative to one or more frequencies of the resonant EM waves, or a phase matching of the nonlinear material;
detecting an output power of one or more output EM waves outputted from the resonator; and
calculating information about the sample from a change in the output power in response to the sample and the modulating.

25. A computer implemented system, comprising:
one or more processors:
receiving, in response to an output power of one or more output electromagnetic (EM) waves outputted from a resonator when the resonator is coupled to a sample, the resonator comprising a nonlinear material comprising a nonlinear susceptibility configured to convert a pump electromagnetic (EM) wave to a signal EM wave and an idler EM wave, wherein at least one of the pump EM wave, the signal EM wave or the idler EM wave is fed back through the nonlinear material to form one or more resonant photons;
controlling modulation of at least one of a pump power of the pump EM wave, a detuning of the frequency modes of a resonator relative to one or more frequencies of the resonant photons, or a phase matching of a nonlinear material when the sample is coupled to the resonator, and
calculating information about the sample from a change in the output power in response to the sample and the modulation.

24. An optical parametric oscillator (OPO)-based molecular sensor comprising an optical parametric oscillator, which is an optical resonator featuring a quadratic nonlinearity that is used to down-convert pump photons into signal and idler photons, a molecular sample, which can either be allowed to flow freely over the optical cavity or housed in a gas cell or microfluidic cell placed inside the cavity, a photodetector, which is used to monitor the sensor output; and an optical cavity coupled to a mechanism for tuning the round-trip delay, which can be provided through a piezoelectric actuator for mechanical tuning or an electrooptic modulator for electrical tuning of the refractive index of the optical path. This tuning may also be effectively achieved external to the cavity through tuning of the pump frequency. The cavity may be constructed in free space using multiple mirrors in, for example, a bowtie configuration, in optical fibers, or in a

25. The OPO-based sensor wherein the OPO is configured to operate using unique nonlinear dynamical behaviors, including spectral phase transitions and temporal simulton formation. Spectral phase transitions occur as the OPO transitions from degenerate operation, where the signal and idler both resonate at the half-harmonic of the pump, to nondegenerate operation. These sharp transitions are very sensitive to changes in the loss and dispersion profiles of the resonator, making them particularly useful for monitoring the addition of the sample to the cavity. Simultons are a co-propagating bright-dark soliton pairs in the signal and pump which have been shown to form in an OPO operating at degeneracy under the proper conditions. One primary feature of this regime of OPOs is a high slope efficiency near threshold, meaning that the simulton bas a particularly sharp response to the addition of gain and loss to the cavity, making it especially useful for near-threshold sensing

26. The OPO configured for broadband molecular sensing, e.g., for a variety of tasks ranging from fundamental studies to medical diagnostics and industrial process monitoring.

27. A mid-infrared molecular sensor system and method utilizing nonlinear dynamics of quadratic cavity soliton formation in optical parametric oscillators to simultaneously achieve high sensitivity and large dynamic range when sensing a sample of interest. In one embodiment, the sample is CO₂ in an OPO at 4.18 μm, wherein simulations show a path length enhancement of 2491 and orders of magnitudes sensitivity enhancement when compared to linear methods at large gas concentrations. This sensitivity enhancement breaks the fundamental sensitivity limitations imposed by the BeerLambert Law.

28. The sensor of one or more of the examples, wherein the resonator comprises an SRO OPO tuned over a spectral range for performing spectroscopy, wherein the output power as a function of tuning is used to reconstruct the intracavity absorption spectrum. In one example, the OPO is just a narrow linewidth tunable source.

29. The sensor of any of the examples 1-28, wherein the sample is in a gas cell.

30. The sensor of any of the examples 1-28, wherein the resonator comprises an optical parametric oscillator comprising an optical parametric amplifier with a cavity around it.

31. The sensor of any of the examples 1-30, comprising a singly-resonant OPO comprising the resonator, wherein either the signal or idler can be resonant and any of the pump, the small outcoupled resonant wave or the non-resonant wave can be measured (e.g., have the output power measured) on the photodetector.

b. Method of Sensing

In one example, molecular sensing is achieved by analyzing the interaction of the generated signal and idler photons with the sample in the cavity, wherein the interaction yields a different response for each of the resonances of the OPO as the delay is tuned due to the unique frequency content of each of the resonances. Through continuous scanning of the delay and monitoring of the power in each resonance on a photodetector, one can acquire real time sensor data about the molecular sample of interest.

FIG. 8 is a flowchart illustrating a method of sensing according to one or more embodiments of the present invention.

Block 1400 represents coupling a sample to a resonator comprising a nonlinear material comprising a nonlinear susceptibility configured to convert a pump electromagnetic (EM) wave to a signal EM wave and an idler EM wave, wherein at least one of the pump EM wave, the signal EM wave or the idler EM wave is fed back through the nonlinear material to form one or more resonant EM wave.

Block 1402 represents controlling/modulating/actuating at least one of a pump power of the pump EM wave, a detuning of the frequency modes of the resonator relative to one or more frequencies of the resonant EM waves, or a phase matching of the nonlinear material;

Block 1404 represents detecting an output power of one or more output EM waves outputted from the resonator.

Block 1406 represents calculating/determining information about the sample from a change in the output power in response to the sample and the modulating. In one or more examples, the computer determines the information by comparing the output power (e.g., amplitude and/or shape) to a calculated output power calculated using a model of a response of the resonator coupled to the sample interacting with the resonant EM waves. In some examples, the computer determines the information using a machine learning algorithm trained using training data, wherein the training data comprises an association between (1) a concentration or composition of the sample, and (2) the output power as a function of at least one of the pump power, the detuning, or the phase matching.

### Advantages and Improvements

Embodiments of the present invention provide numerous novel and useful features.
1. Achieving broadband molecular sensing without performing spectroscopy. This is particularly important in terms of scalability and affordability as traditional spectrometers are often bulky or expensive, requiring additional components such as gratings, spectral filters, reference optical combs, as in the case of dual-comb spectroscopy, or large delays, as in the case of Fourier-transform spectroscopy. In an OPO-based sensor according to embodiments described herein, there is effectively a nonlinear mapping from the frequency domain to the time domain in the detected signal due to the unique frequency content of each of the OPO resonances. This can enable broadband sensing requiring only a detector.
2. Ability to leverage the signal enhancement due to both the resonator and the gain provided by the quadratic nonlinearity. The linear cavity enhancement is a result of the effective absorption path length increase due to the multiple passages of light through the sample in the cavity while the active cavity enhancement can also benefit from near-threshold dynamics in the active cavity due to the interplay of gain and loss.
3. Operation and phase transitions and in the simulton regime. Such dynamics enable a fundamentally different sensing scheme that can break many of the limitations of current techniques to achieve high sensitivity, large signal enhancement, and considerable dynamic range for mid-infrared gas sensing while avoiding the typical requirements of high-finesse and high-power operation. Moreover, simultons can be achieved at arbitrary wavelengths, enabling a universal molecular sensing scheme, particularly useful in wavelength ranges where lasers are not readily available. For example, for an OPO with 4 micron wavelength output, we have measured an equivalent path length enhancement as high as 2491 close to threshold and a maximum sensitivity of 4.1 mW/ppm even at concentrations of CO₂ as high as atmospheric levels³⁴. As illustrated herein, this sensitivity of the simulton at large gas concentrations is shown to be orders of magnitude larger than what can theoretically be achieved through linear methods using a probe of equivalent power and bandwidth to the output of our broadband OPO.

Due to these features, the OPO-based sensor can provide high sensitivities, large dynamic range, and scalability in performing multispecies molecular sensing for samples including gases, liquids, or biological tissues. In terms of scalability specifically, we emphasize here the exciting possibilities afforded by movement to integrated photonics due to the especially strong nonlinearity and flexibility afforded by the strong mode confinement and dispersion engineering in such devices. These features can enable the creation of high-performance sensors tailored to a given application of interest. Applications that can be particularly benefitted include, but are not limited to, applications where precise measurement of a wide range of concentrations is required.

### Hardware Environment

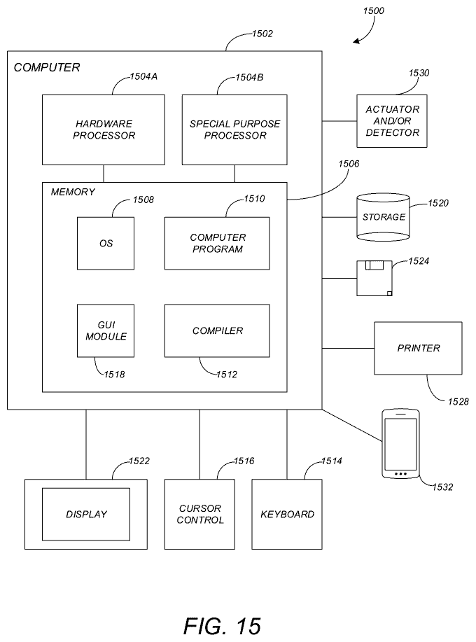

FIG. 15 is an exemplary hardware and software environment 1500 (referred to as a computer-implemented system and/or computer-implemented method) used to implement one or more embodiments of the invention. The hardware and software environment includes a computer 1502 and may include peripherals. Computer 1502 may be a user/client computer, server computer, or may be a database computer. The computer 1502 comprises a hardware processor 1504A and/or a special purpose hardware processor 1504B (hereinafter alternatively collectively referred to as processor 1504) and a memory 1506, such as random access memory (RAM). The computer 1502 may be coupled to, and/or integrated with, other devices, including input/output (I/O) devices such as a keyboard 1514, a cursor control device 1516 (e.g., a mouse, touch screen, multi-touch device, etc.) and a printer 1528. In one or more embodiments, computer 1502 may be coupled to, or may comprise, a portable or media viewing/listening device 1532 (e.g., cellular device, personal digital assistant, etc.). In yet another embodiment, the computer 1502 may comprise a multi-touch device, mobile phone or other internet enabled device executing on various platforms and operating systems.

In one embodiment, the computer 1502 operates by the hardware processor 1504A performing instructions defined by the computer program 1510 (e.g., for performing calculations described herein or control actuation as described herein) under control of an operating system 1508. The computer program 1510 and/or the operating system 1508 may be stored in the memory 1506 and may interface with the user and/or other devices to accept input and commands and, based on such input and commands and the instructions defined by the computer program 1510 and operating system 1508, to provide output and results.

Output/results may be presented on the display 1522 or provided to another device for presentation or further processing or action. The image may be provided through a graphical user interface (GUI) module 1518. Although the GUI module 1518 is depicted as a separate module, the instructions performing the GUI functions can be resident or distributed in the operating system 1508, the computer program 1510, or implemented with special purpose memory and processors. In one or more embodiments, the display 1522 is integrated with/into the computer 1502 and comprises a multi-touch device having a touch sensing surface (e.g., track pod or touch screen) with the ability to recognize the presence of two or more points of contact with the surface.

Some or all of the operations performed by the computer 1502 according to the computer program 1510 instructions may be implemented in a special purpose processor 1504B. In this embodiment, some or all of the computer program 1510 instructions may be implemented via firmware instructions stored in a read only memory (ROM), a programmable read only memory (PROM) or flash memory within the special purpose processor 1504B or in memory 1506. The special purpose processor 1504B may also be hardwired through circuit design to perform some or all of the operations to implement the present invention. Further, the special purpose processor 1504B may be a hybrid processor, which includes dedicated circuitry for performing a subset of functions, and other circuits for performing more general functions such as responding to computer program 1510 instructions. In one embodiment, the special purpose processor 1504B is an application specific integrated circuit (ASIC) or field programmable gate array, or other circuit (e.g., integrated circuit), or processors for performing artificial intelligence/machine learning.

The computer 1502 may also implement a compiler 1512 that allows an application or computer program 1510 written in a programming language such as C, C++, Assembly, SQL, PYTHON, PROLOG, MATLAB, RUBY, RAILS, HASKELL, or other language to be translated into processor 1504 readable code. Alternatively, the compiler 1512 may be an interpreter that executes instructions/source code directly, translates source code into an intermediate representation that is executed, or that executes stored precompiled code. Such source code may be written in a variety of programming languages such as JAVA, JAVASCRIPT, PERL, BASIC, etc. After completion, the application or computer program 1510 accesses and manipulates data accepted from I/O devices and stored in the memory 1506 of the computer 1502 using the relationships and logic that were generated using the compiler 1512.

The computer 1502 also optionally comprises an external communication device such as a modem, satellite link, Ethernet card, or other device for accepting input from, and providing output to, other computers 1502.

In one embodiment, instructions implementing the operating system 1508, the computer program 1510, and the compiler 1512 are tangibly embodied in a non-transitory computer-readable medium, e.g., data storage device 1520, which could include one or more fixed or removable data storage devices, such as a zip drive, floppy disc drive 1524, hard drive, CD-ROM drive, tape drive, etc. Further, the operating system 1508 and the computer program 1510 are comprised of computer program 1510 instructions which, when accessed, read and executed by the computer 1502, cause the computer 1502 to perform the steps necessary to implement and/or use the present invention or to load the program of instructions into a memory 1506, thus creating a special purpose data structure causing the computer 1502 to operate as a specially programmed computer executing the method steps described herein. Computer program 1510 and/or operating instructions may also be tangibly embodied in memory 1506 and/or data communications devices 1530, thereby making a computer program product or article of manufacture according to the invention. As such, the terms “article of manufacture,” “program storage device,” and “computer program product,” as used herein, are intended to encompass a computer program accessible from any computer readable device or media.

Of course, those skilled in the art will recognize that any combination of the above components, or any number of different components, peripherals, and other devices, may be used with the computer 1502.

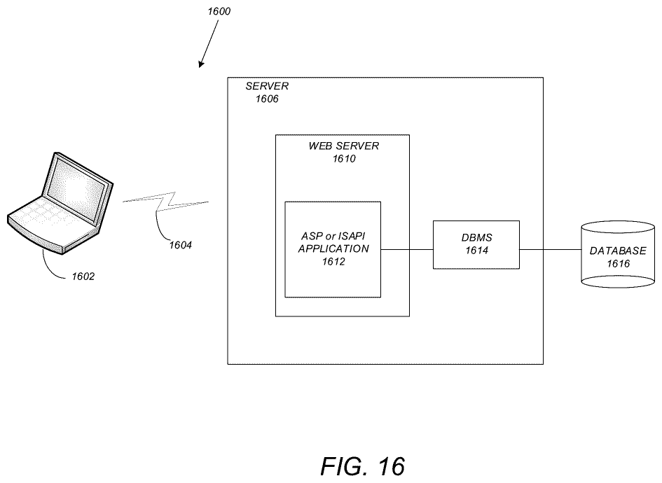

FIG. 16 schematically illustrates a typical distributed/cloud-based computer system 1600 using a network 1604 to connect client computers 1602 to server computers 1606. A typical combination of resources may include a network 1604 comprising the Internet, LANs (local area networks), WANs (wide area networks), SNA (systems network architecture) networks, or the like, clients 1602 that are personal computers or workstations (as set forth in FIG. 15), and servers 1606 that are personal computers, workstations, minicomputers, or mainframes (as set forth in FIG. 15). However, it may be noted that different networks such as a cellular network (e.g., GSM [global system for mobile communications] or otherwise), a satellite based network, or any other type of network may be used to connect clients 1602 and servers 1606 in accordance with embodiments of the invention. A network 1604 such as the Internet connects clients 1602 to server computers 1606. Network 1604 may utilize ethernet, coaxial cable, wireless communications, radio frequency (RF), etc. to connect and provide the communication between clients 1602 and servers 1606. Further, in a cloud-based computing system, resources (e.g., storage, processors, applications, memory, infrastructure, etc.) in clients 1602 and server computers 1606 may be shared by clients 1602, server computers 1606, and users across one or more networks. Resources may be shared by multiple users and can be dynamically reallocated per demand. In this regard, cloud computing may be referred to as a model for enabling access to a shared pool of configurable computing resources. Clients 1602 may execute a client application or web browser and communicate with server computers 1606 executing web servers 1610. Such a web browser is typically a program such as MICROSOFT INTERNET EXPLORER/EDGE, MOZILLA FIREFOX, OPERA, APPLE SAFARI, GOOGLE

CHROME, etc. Further, the software executing on clients 1602 may be downloaded from server computer 1606 to client computers 1602 and installed as a plug-in or ACTIVEX control of a web browser. Accordingly, clients 1602 may utilize ACTIVEX components/component object model (COM) or distributed COM (DCOM) components to provide a user interface on a display of client 1602. The web server 1610 is typically a program such as MICROSOFT'S INTERNET INFORMATION SERVER. Web server 1610 may host an Active Server Page (ASP) or Internet Server Application Programming Interface (ISAPI) application 1612, which may be executing scripts. The scripts invoke objects that execute business logic (referred to as business objects). The business objects then manipulate data in database 1616 through a database management system (DBMS) 1614. Alternatively, database 1616 may be part of, or connected directly to, client 1602 instead of communicating/obtaining the information from database 1616 across network 1604. When a developer encapsulates the business functionality into objects, the system may be referred to as a component object model (COM) system. Accordingly, the scripts executing on web server 1610 (and/or application 1612) invoke COM objects that implement the business logic. Further, server 1606 may utilize MICROSOFT'S TRANSACTION SERVER (MTS) to access required data stored in database 1616 via an interface such as ADO (Active Data Objects), OLE DB (Object Linking and Embedding DataBase), or ODBC (Open DataBase Connectivity).

Generally, these components 1600-1616 all comprise logic and/or data that is embodied in/or retrievable from device, medium, signal, or carrier, e.g., a data storage device, a data communications device, a remote computer or device coupled to the computer via a network or via another data communications device, etc. Moreover, this logic and/or data, when read, executed, and/or interpreted, results in the steps necessary to implement and/or use the present invention being performed.

Although the terms “user computer”, “client computer”, and/or “server computer” are referred to herein, it is understood that such computers 1602 and 1606 may be interchangeable and may further include thin client devices with limited or full processing capabilities, portable devices such as cell phones, notebook computers, pocket computers, multi-touch devices, and/or any other devices with suitable processing, communication, and input/output capability.

Of course, those skilled in the art will recognize that any combination of the above components, or any number of different components, peripherals, and other devices, may be used with computers 1602 and 1606. Embodiments of the invention are implemented as a software/CAD application on a client 1602 or server computer 1606. Further, as described above, the client 1602 or server computer 1606 may comprise a thin client device or a portable device that has a multi-touch-based display.

In one or more examples, a computer implemented system comprises one or more processors receiving an output power of one or more output electromagnetic (EM) waves outputted from a resonator when the resonator is coupled to a sample, the resonator comprising a nonlinear material comprising a nonlinear susceptibility configured to convert a pump electromagnetic (EM) wave to a signal EM wave and an idler EM wave, wherein at least one of the pump EM wave, the signal EM wave or the idler EM wave is fed back through the nonlinear material to form one or more resonant photons; controlling modulation/actuation of at least one of a pump power of the pump EM wave, a detuning of the frequency modes of a resonator relative to one or more frequencies of the resonant photons, or a phase matching of a nonlinear material when the sample is coupled to the resonator, and calculating information about the sample from a change in the output power in response to the sample and the modulation/actuation. In one or more examples, the computer includes one or more processors; one or more memories; and an application/program stored in the one or more memories, wherein the application executed by the one or more processors receives the output power and calculates the information.

### REFERENCES

The following references are incorporated by reference herein.

### REFERENCES FOR THE FIRST EXAMPLE

1 J. Hodgkinson and R. P. Tatam, Meas. Sci. Technol. 24, 012004 (2012).
2 Appl. physics. B 124, 161 (2018).
3 Optica 6, 165-168 (2019).
4 Nat. Photonics 12, 202-208 (2018).
5 Nat. Photonics 12, 209-214 (2018).
6 arXiv 2107.08333 (2021). 7. Nat. Photonics 6, 440-449 (2012).
7 Science 371, eabe0722 (2021).
8 Optica 3, 324-327 (2016).
9 Phys. Rev. A 94, 063809 (2016).
10 Conf. on Lasers Electro-Optics p. SF3R.4 (2020).
11 Nat. Commun. 12, 835 (2021).
12 Optica 9, 303-308 (2022).

### REFERENCES FOR THE SECOND EXAMPLE

1 Hodgkinson, J. & Tatam, R. P. Optical gas sensing: a review. Measurement Science and Technology 24, 012004 (2012). 2. Yang, Z., Albrow-Owen, T., Cai, W. & Hasan, T. Miniaturization of optical spectrometers. Science 371, eabe0722 (2021).
2 O'Keefe, A. & Deacon, D. A. Cavity ring-down optical spectrometer for absorption measurements using pulsed laser sources. Review of scientific instruments 59, 2544-2551 (1988)
3 Gagliardi, G. & Loock, H.-P. Cavity-enhanced spectroscopy and sensing (Springer, 2014).
4 Thorpe, M. J., Moll, K. D., Jones, R. J., Safdi, B. & Ye, J. Broadband cavity ringdown spectroscopy for sensitive and rapid molecular detection. Science 311, 1595-1599 (2006).
5 Bernhardt, B. et al. Cavity-enhanced dual-comb spectroscopy. Nature photonics 4, 55-57 (2010)
6 Reber, M. A., Chen, Y. & Allison, T. K. Cavity-enhanced ultrafast spectroscopy: ultrafast meets ultrasensitive. Optica 3, 311-317 (2016).
7 Foltynowicz, A., Ban, T., Masłowski, P., Adler, F. & Ye, J. Quantum-noise-limited optical frequency comb spectroscopy. Physical review letters 107, 233002 (2011).
8 Langridge, J. et al. Cavity enhanced absorption spectroscopy of multiple trace gas species using a supercontinuum radiation source. Optics Express 16, 10178-10188 (2008).
9 Zondlo, M. A., Paige, M. E., Massick, S. M. & Silver, J. A. Vertical cavity laser hygrometer for the National Science Foundation Gulfstream-V aircraft. Journal of Geophysical Research: Atmospheres 115 (2010).
10 Lou, X., Feng, Y., Yang, S. & Dong, Y. Ultra-wide-dynamic-range gas sensing by optical pathlength multiplexed absorption spectroscopy. Photonics Research 9, 193-201 (2021).
11 Altmann, J., Baumgart, R. & Weitkamp, C. Two-mirror multipass absorption cell. Applied Optics 20, 995-999 (1981).
12 Tuzson, B., Mangold, M., Looser, H., Manninen, A. & Emmenegger, L. Compact multipass optical cell for laser spectroscopy. Optics letters 38, 257-259 (2013).
13 Dong, M. et al. Double-range near-infrared acetylene detection using a dual spot-ring Herriott cell (DSR-HC). Optics Express 26, 12081-12091 (2018).
14 Antonov, E., Koloshnikov, V. & Mironenko, V. Quantitative measurement of small absorption coefficients in intracavity absorption spectroscopy using a cw dye laser. Optics Communications 15, 99-103 (1975).
15 Goldman, A. & Cheskis, S. Intracavity laser absorption spectroscopy of sooting acetylene/air flames. Applied Physics B 92, 281-286 (2008).
16 Baev, V. M., Latz, T. & Toschek, P. E. Laser intracavity absorption spectroscopy. Applied Physics B 69, 171-202 (1999).
17 Träger, F., Neumann, R., Kowalski, J. & Putlitz, G. z. Intracavity atomic beam laser spectrometer for low intensity spectral lines. Applied physics 12, 19-22 (1977). 19. Kleist, E. & Bettermann, H. Intracavity absorption measurements from liquid samples in an Art-ion laser. Optics letters 13, 449-451 (1988).
18 Gilmore, D., Cvijin, P. V. & Atkinson, G. Intracavity absorption spectroscopy with a titanium: sapphire laser. Optics communications 77, 385-389 (1990).
19 Belkin, M. A. et al. Intra-cavity absorption spectroscopy with narrow-ridge microfluidic quantum cascade lasers. Optics Express 15, 11262-11271 (2007).
20 Garnache, A., Kachanov, A., Stoeckel, F. & Houdre, R. Diode-pumped broadband verticalexternal-cavity surface-emitting semiconductor laser applied to high-sensitivity intracavity absorption spectroscopy. JOSA B 17, 1589-1598 (2000).
21 Löhden, B. et al. Fiber laser intracavity absorption spectroscopy for in situ multicomponent gas analysis in the atmosphere and combustion environments. Applied Physics B 102, 331-344 (2011).
22 Zhang, Y. et al. Investigation of erbium-doped fiber laser intra-cavity absorption sensor for gas detection. Optics Communications 232, 295-301 (2004).
23 Fjodorow, P., Hellmig, O. & Baev, V. M. A broadband Tm/Ho-doped fiber laser tunable from 1.8 to 2.09 μm for intracavity absorption spectroscopy. Applied Physics B 124, 1-8 (2018)
24 Stark, A. et al. Intracavity absorption spectroscopy with thulium-doped fibre laser. Optics communications 215, 113-123 (2003).
25 Fjodorow, P. et al. Room-temperature Fe:ZnSe laser tunable in the spectral range of 3.75.3 μm applied for intracavity absorption spectroscopy of CO₂ isotopes, CO and N₂O. Optics Express 29, 12033-12048 (2021).
26 Melentiev, P. et al. Plasmonic nanolaser for intracavity spectroscopy and sensorics. Applied Physics Letters 111, 213104 (2017).
27 Brunner, W. & Paul, H. The optical parametric oscillator as a means for intracavity absorption spectroscopy. Optics Communications 19, 253-256 (1976).
28 Babin, A. A., Petryakov, V. N. & Freidman, G. Feasibility of using singly resonant parametric oscillators for intracavity infrared spectroscopy. Soviet Journal of Quantum Electronics 11, 664 (1981).
29 Boller, K.-J. & Schröder, T. Demonstration of broadband intracavity spectroscopy in a pulsed optical parametric oscillator made of β-barium borate. JOSA B 10, 1778-1784 (1993).
30 Haakestad, M. W., Lamour, T. P., Leindecker, N., Marandi, A. & Vodopyanov, K. L. Intracavity trace molecular detection with a broadband mid-IR frequency comb source. JOSA B 30, 631-640 (2013).
31 Jankowski, M. et al. Temporal simultons in optical parametric oscillators. Physical Review Letters 120, 053904 (2018). 34. Liu, M. et al. High-Power Mid-IR Few-Cycle Frequency Comb from Quadratic Solitons in an Optical Parametric Oscillator. Laser & Photonics Reviews 16, 2200453. eprint: https://onlinelibrary.wiley.com/doi/pdf/10.1002/lpor.202200453.https://onlinelibrary•wiley.com/doi/abs/10.1002/lpor.202200453(2022).
32 Marandi, A., Ingold, K. A., Jankowski, M. & Byer, R. L. Cascaded half-harmonic generation of femtosecond frequency combs in the mid-infrared. Optica 3, 324-327 (2016).
33 Marandi, A., Leindecker, N. C., Pervak, V., Byer, R. L. & Vodopyanov, K. L. Coherence properties of a broadband femtosecond mid-IR optical parametric oscillator operating at degeneracy. Optics express 20, 7255-7262 (2012).
34 Muraviev, A., Smolski, V., Loparo, Z. & Vodopyanov, K. Massively parallel sensing of trace molecules and their isotopologues with broadband subharmonic mid-infrared frequency combs. Nature Photonics 12, 209-214 (2018).
35 Akhmanov, S. et al. Nonstationary nonlinear optical effects and ultrashort light pulse formation. IEEE Journal of Quantum Electronics 4, 598-605 (1968).
36 Trillo, S. Bright and dark simultons in second-harmonic generation. Optics letters 21, 1111-1113 (1996).
37 Ledezma, L. et al. Intense optical parametric amplification in dispersion-engineered nanophotonic lithium niobate waveguides. Optica 9, 303-308. https://opg.optica.org/optica/abstract.cfm?URI-optica-9-3-303 (March 2022).
38 Ledezma, L. et al. Widely-tunable optical parametric oscillator in lithium niobate nanophotonics. arXiv preprint arXiv: 2203.11482 (2022).
39 Roy, A., Jahani, S., Langrock, C., Fejer, M. & Marandi, A. Spectral phase transitions in optical parametric oscillators. Nature communications 12, 1-9 (2021).
40 Zhou, S., Gray, R., Liu, M., Roy, A. & Marandi, A. Towards gas sensing without spectroscopy using mid-infrared optical parametric oscillators in Optical Sensors (2022), SMIE-1.
41 Gordon, I. et al. The HITRAN2020 molecular spectroscopic database. Journal of Quantitative Spectroscopy and Radiative Transfer 277, 107949 (2022).

### REFERENCES FOR THIRD EXAMPLE

1 Liu, M. et al. High-Power Mid-IR Few-Cycle Frequency Comb from Quadratic Solitons in an Optical Parametric Oscillator. Laser & Photonics Reviews 16, 2200453. eprint: https://onlinelibrary.wiley.com/doi/pdf/10.1002/lpor.202200453. https://onlinelibrary.wiley.com/doi/abs/10.1002/lpor.202200453.
2 Jankowski, M. et al. Temporal simultons in optical parametric oscillators. Physical Review Letters 120, 053904 (2018).
3 Wei, J. et al. Temperature dependent Sellmeier equation for the refractive index of GaP. Optical Materials Express 8, 485-490 (2018).
4 Demtröder, W. Laser spectroscopy 1: basic principles (Springer, 2014).
5 Gordon, I. et al. The HITRAN2020 molecular spectroscopic database. Journal of Quantitative Spectroscopy and Radiative Transfer 277, 107949 (2022).
6 Romanini, D., Ventrillard, I., Méjean, G., Morville, J. & Kerstel, E. in Cavity-Enhanced Spectroscopy and Sensing 1-60 (Springer, 2014).
7 Baev, V. M., Latz, T. & Toschek, P. E. Laser intracavity absorption spectroscopy. Applied Physics B 69, 171-202 (1999).
8 Byer, R. L. Optical parametric oscillators. Quantum electronics: A treatise 1 (1975).
9 Jankowski, M. Pulse Formation and Frequency Conversion in Dispersion-Engineered Nonlinear Waveguides and Resonators (Stanford University, 2020).
10 Hamerly, R. et al. Reduced models and design principles for half-harmonic generation in synchronously pumped optical parametric oscillators. Physical Review A 94, 063809 (2016)

### REFERENCES FOR FOURTH EXAMPLE

[1] S. T. Yang, R. C. Eckardt, and R. L. Byer, “Power and spectral characteristics of continuous-wave parametric oscillators: the doubly to singly resonant transition,” J. Opt. Soc. Am. B 10, 1684-1695 (1993)

### CONCLUSION

This concludes the description of the preferred embodiment of the present invention. The foregoing description of one or more embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A sensor, comprising:
a resonator comprising a nonlinear material comprising a nonlinear susceptibility configured to convert a pump electromagnetic wave (EM) wave to a signal EM wave and an idler EM wave, wherein at least one of the pump EM wave, the signal EM wave and/or the idler EM wave is fed back through the nonlinear material to form one or more resonant EM waves;
an actuator coupled to the resonator or a pump path to the resonator, for controlling at least one of a pump power of the pump EM wave, a detuning of the frequency modes of the resonator relative to one or more frequencies of the resonant EM waves, or a phase matching of the nonlinear material; and
an output of the resonator, for outputting one or more output EM waves comprising information about a sample coupled to the resonator.

2. The sensor of claim 1, further comprising:
a detector coupled to the output of the resonator, for detecting an output power of the one or more output EM waves; and
a computer coupled to the detector, wherein the computer is configured to determine the information about the sample from a change in the output power when the resonant EM waves are coupled to the sample.

3. The sensor of claim 2, wherein the computer is configured to:
determine the information by comparing the output power to a calculated output power calculated using a model of a response of the resonator coupled to the sample interacting with the resonant EM waves and/or,
determine the information using a machine learning algorithm trained using training data, wherein:
the training data comprises an association between:
a concentration or composition of the sample, and
the output power as a function of at least one of the pump power, the detuning, or the phase matching, and/or
determines the information by only analyzing the change in the output power.

4. The sensor of claim 1, further comprising an optical parametric oscillator (OPO) comprising the resonator.

5. The sensor of claim 4, wherein the OPO is configured to operate at a phase transition between degenerate and non-degenerate operation.

6. The sensor of claim 4, wherein the OPO is configured to:
operate near threshold for lasing of the resonant EM waves, and
the EM comprise simultons,
so that a sensitivity of the sensor to a change in the sample is enhanced by near-threshold dynamics such as simulton or other soliton formation mechanisms.

7. The sensor of claim 4, wherein the actuator changes operation of the OPO from below a threshold (for lasing of the resonant EM waves) to above the threshold.

8. The sensor of claim 1, wherein the resonator is configurable to operate near oscillation threshold for lasing of the resonant EM waves, as characterized by 0.9≤pump power/threshold pump power≤3 or
the actuator is configurable to set the detuning or the phase matching so that the resonator operates at least at a spectral phase transition between degenerate and non-degenerate operation and/or the resonant EM waves comprise simultons.

9. The sensor of claim 1, wherein the actuator causes the resonant EM waves in the resonator to follow a predictable spectral tuning and the output EM waves can be used to reconstruct the function of a tunable laser spectrometer.

10. The sensor of claim 1, wherein the actuator is configured to modulate at least one of the pump power, the detuning, or the phase matching to tune a dynamic range, sensitivity, or selectivity of the sensor.

11. The sensor of claim 1, wherein the information comprises at least a concentration or a composition differentiation of the sample comprising one or more molecules.

12. The sensor of claim 1, wherein the information comprises a physical or chemical property of the sample comprising a solid, liquid, or gas.

13. The sensor of claim 1, wherein the information is outputted in real time with a change in the sample and with a temporal resolution limited by a modulation or actuation speed of the actuator and acquisition time of the information.

14. The sensor of claim 1, wherein the actuator comprises at least one of an actuator configured to tune a length of the resonator, a heater or cooler thermally coupled to the resonator for modulating the phase matching and/or the length of the resonator, an electro-optic modulator capable of tuning a refractive index of a path length in the cavity, an electro-optic mirror or beamsplitter for controlling a power of the pump EM wave, or a control circuit coupled to a pump source for tuning a frequency or power of the pump EM wave outputted from the pump source.

15. The sensor of claim 1, wherein the actuator comprises a scanner applying one or more ramp functions modulating at least one of the pump power, the detuning, or the phase matching.

16. One or more chips or photonic integrated circuits comprising the sensor of claim 1.

17. The sensor of claim 1, further comprising means for making the resonant EM wave of the resonator interact with the sample, wherein the means comprises a sample container positioned to couple the sample to the resonator through an evanescent field, a slot waveguide, an optical fiber, a chamber in the resonator, a fluidic coupling, a free space coupling, or a hollow core fiber.

18. The sensor of claim 1, wherein:
the resonator comprises a cavity comprising the nonlinear material between mirrors, and the cavity comprises a sample space for positioning the sample within the cavity.

19. The sensor of claim 1, wherein the resonator comprises an optical fiber loop coupled to the nonlinear material.

20. An analyzer comprising the sensor of claim 1 outputting the information about the sample comprising breath, an atmospheric concentration of a pollutant or greenhouse gas, or a process gas monitored in an industrial setting.

21. The sensor of claim 1, wherein the information comprises a concentration of the sample in a range of part per trillion volume to several precents causing saturation in a linear absorption sensor according to the Beer Lambert Law.

22. A method of sensing, comprising:
coupling a sample to a resonator comprising a nonlinear material comprising a nonlinear susceptibility configured to convert a pump electromagnetic (EM) wave to a signal EM wave and an idler EM wave, wherein at least one of the pump EM wave, the signal EM wave or the idler EM wave is fed back through the nonlinear material to form one or more resonant EM wave;
controlling at least one of a pump power of the pump EM wave, a detuning of the frequency modes of the resonator relative to one or more frequencies of the resonant EM waves, or a phase matching of the nonlinear material;
detecting an output power of one or more output EM waves outputted from the resonator; and
calculating information about the sample from a change in the output power in response to the sample and the modulating.

23. A computer implemented system, comprising:
one or more processors:
receiving an output power of one or more output electromagnetic (EM) waves outputted from a resonator when the resonator is coupled to a sample, the resonator comprising a nonlinear material comprising a nonlinear susceptibility configured to convert a pump electromagnetic (EM) wave to a signal EM wave and an idler EM wave, wherein at least one of the pump EM wave, the signal EM wave or the idler EM wave is fed back through the nonlinear material to form one or more resonant photons;
controlling actuation of at least one of a pump power of the pump EM wave, a detuning of the frequency modes of a resonator relative to one or more frequencies of the resonant photons, or a phase matching of a nonlinear material when the sample is coupled to the resonator, and
calculating information about the sample from a change in the output power in response to the sample and the actuation.
